(19) United States
(12) Patent Application Publication
(10) Pub. No.: US 2010/0160043 A1
(43) Pub. Date: Jun. 24, 2010

(54) GAME MACHINE

(75) Inventors: Jun Fujimoto, Tokyo (JP); Nobuyuki Nonaka, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Aruze Corp, Koto-ku, Tokyo (JP)

(21) Appl. No.: 12/160,496

(22) PCT Filed: Dec. 22, 2006
(86) PCT No.: PCT/JP2006/325629

§ 371 Date: Nov. 5, 2008

(30) Foreign Application Priority Data
Jan. 12, 2006 (JP) 2006-004538

(51) Int. Cl. A63F 13/00; A63F 9/24

(52) U.S. Cl. 463/35; 463/36; 463/43

(57) ABSTRACT

The gaming machine of the present invention is a gaming machine provided with a speaker capable of outputting a sound that is inputted into an external device having a microphone and that enables the device to execute a specific effect when it is determined in the device that the sound includes a specific sound based upon specific data, the gaming machine comprising: a first memory that stores effect pattern data including first sound data; and a controller, the controller programmed to execute the processing of (a) extracting the effect pattern data from the first memory, (b) performing control to execute an effect, based upon the extracted effect pattern data, (c) converting, as triggered by satisfaction of a prescribed condition, the first sound data included in the extracted effect pattern data into second sound data including the specific data that triggers the external device to execute the specific effect, and (d) outputting from the speaker the sound based upon the processed second sound data.

### TECHNICAL FIELD

The present invention relates to a gaming machine such as a pachislo gaming apparatus and a slot machine.

### BACKGROUND ART

Typically, in gaming machines such as a pachislo gaming apparatus and a slot machine inside and outside Japan, a variety of effects are produced by means of a sound emitted from a speaker, a display mode of an illumination lamp provided around a cabinet or the like, an image displayed to a liquid crystal display or the like, and by some other means, in accordance with internal lottery processing (hereinafter also referred to as “internal lottery”) and a gaming state.

There conventionally exists a gaming machine that has a microphone and generates and outputs an additional sub sound based upon an ambient sound recorded with the microphone and a gaming state (e.g., see Patent Document 1). According to the gaming machine described in Patent Document 1, since a sound amplifying an ambient sound is outputted or a suppression sound canceling the ambient sound is outputted in accordance with a gaming state, a player can feel vibrancy in a game parlor when the sound amplifying the ambient sound is outputted and also have a higher expectation by an effect sound emitted from the gaming machine when the sound canceling the ambient sound is outputted.

Patent Document 1: JP-A No. 2005-131263

### DISCLOSURE OF THE INVENTION

### Problems to be Solved by the Invention

However, in the gaming machine described in Patent Document 1, although it is possible to vary effect sounds by outputting a sub sound, such an effect as a sound changing in accordance with a gaming state is within a range of typically produced effects and is thus nothing new; hence, there has been a problem that the player soon gets bored with the game.

Further, even when the player who plays a game on the gaming machine can feel vibrancy in the game parlor and have a higher expectation, there has been a problem that it is not possible to obtain effects of holding the vibrancy in the entire game parlor and raising the expectation of the player who has not yet hit a jackpot.

The present invention was made in view of the foregoing problems, and has an object to provide a gaming machine that is capable of producing a new effect in which contents of a game on one gaming machine are reflected to another gaming machine or the like in a game parlor, and of enhancing vibrancy in the entire game parlor and expectation of a player who has not yet hit a jackpot.

### Means for Solving the Problems

In order to achieve the object as described above, the present invention provides the following.

(1) A gaming machine provided with a speaker capable of outputting a sound that is inputted into an external device having a microphone and that enables the device to execute a specific effect when it is determined in the device that the sound includes a specific sound based upon specific data, the gaming machine comprising:

a first memory that stores effect pattern data including first sound data; and

a controller,

the controller programmed to execute the processing of

(a) extracting the effect pattern data from the first memory,

(b) performing control to execute an effect, based upon the extracted effect pattern data,

(c) converting, as triggered by satisfaction of a prescribed condition, the first sound data included in the extracted effect pattern data into second sound data including the specific data that triggers the external device to execute the specific effect, and

(d) outputting from the speaker the sound based upon the processed second sound data.

According to the invention of (1), as triggered by satisfaction of a prescribed condition (e.g. generation of a special gaming state, reaching of a prescribed number by the number of payouts of game media or a difference in number of the game media, coming of prescribed time, and passing of a prescribed period from start of a game or from play of a last game), first sound data included in effect pattern data is converted into second sound data including specific data that triggers an external device to execute a specific effect, and a sound based upon the second sound data is outputted from a speaker. When the sound outputted from the speaker is inputted into an external device (e.g. another gaming machine) having a microphone, it is determined in the device that the sound includes the specific sound, and a specific effect is executed. Since the sound outputted from the speaker spreads therearound, a specific effect is executed in the external device installed around the gaming machine that has satisfied the prescribed condition.

As thus described, according to the invention of (1), it is possible to produce a completely new effect where, when a prescribed condition is satisfied in one gaming machine, a device around the machine produces an effect as if it resonates. The effect involving another player in the game parlor enhances vibrancy in the entire game parlor and expectation of a player who has not been able to satisfy the prescribed condition (e.g. player who has not yet hit a jackpot).

Further, since the prescribed effect is executed in the external device, the player playing a game on the gaming machine that has satisfied the prescribed condition can feel a sense of superiority. Moreover, when the sound including the specific sound is outputted, the external device having a microphone therein collects the sound, and it is thus unnecessary to perform a wiring operation such as connection between the gaming machines or between the gaming machines and a management device. As thus described, since it is configured so as to produce an effect through sounds, the cost and time taken for investment in facilities can be reduced.

Moreover, when it is configured such that a sound outputted from the speaker is collected by equipment having a microphone therein in the game parlor, it is possible in the equipment to execute an effect of playing prescribed music or a voice in the parlor, an effect of applying a spotlight in a direction toward the gaming machine that has emitted the sound, and the like.

Further, the present invention provides the following.

(2) The gaming machine according to the above-mentioned (1),

wherein

the controller performs, in the processing (c), processing of converting the first sound data included in the extracted effect pattern data into second sound data including the specific data that shows a specific waveform.

According to the invention of (2), as triggered by satisfaction of the prescribed condition, processing is performed in which the first sound data included in the effect pattern data is converted into second sound data including specific data that shows a specific waveform. When a sound based upon the second sound data outputted from the speaker is inputted into an external device having a microphone, it is determined in the device that part of a waveform shown by a sound signal outputted from the microphone includes a waveform identical or similar to the specific waveform, and a specific effect is executed. Therefore, according to the invention of (2), it is directly determined from the waveform whether or not the specific sound is included, thereby allowing prevention of malfunction.

Further, the present invention provides the following.

(3) The gaming machine according to the above-mentioned (2),

wherein

the controller performs, in the processing (c), processing of converting the first sound data included in the extracted effect pattern data into second sound data including the specific data that shows a waveform obtained by amplifying by a prescribed amount an amplitude in a specific frequency band of a waveform shown by the first sound data.

According to the invention of (3), processing is performed in which the first sound data included in the effect pattern data is converted into second sound data including specific data that shows a waveform obtained by amplifying by a prescribed amount an amplitude in a specific frequency band of a waveform shown by the first sound data. When a sound based upon the second sound data outputted from the speaker is inputted into an external device having a microphone, it is determined in the device that part of a waveform shown by the sound signal outputted from the microphone includes a specific waveform with an amplitude in a specific frequency band different by a prescribed amount from a reference amplitude, and a specific effect is executed. Therefore, according to the invention of (3), for example, equalizer processing (processing of adjusting a level of a sound signal in each of a plurality of frequency bands different from one another) or the like may be performed, and it is thus possible to process a sound by a relatively simple technique.

Further, present invention provides the following.

(4) The gaming machine according to the above-mentioned (2),

wherein

the controller performs, in the processing (c), processing of converting the first sound data included in the extracted effect pattern data into second sound data including the specific data that shows a waveform of a specific inaudible sound.

According to the invention of (4), processing is performed in which the first sound data included in the effect pattern data is converted into second sound data including specific data that shows a waveform of a specific inaudible sound. When a sound based upon the second sound data outputted from the speaker is inputted into an external device having a microphone, it is determined in the device that part of a waveform shown by the sound signal outputted from the microphone includes the waveform of the specific inaudible sound, and a specific effect is executed. It is therefore possible to execute the effect without making the player aware of a change in sound outputted from the gaming machine.

It is to be noted that the inaudible sound refers to a sound with a frequency of other than a generally human-recognizable range of 20 Hz to 20000 Hz, but it is not necessarily required to be a sound with a frequency of other than 20 Hz to 20000 Hz, depending upon a mode in which the sound is outputted. Namely, in the present invention, the inaudible sound includes a sound outputted in a human-unrecognizable mode, e.g. a mode as seen in the case where a sound cannot be recognized by a human when outputted at a low volume after output of a sound at a high volume.

Further, the present invention provides the following.

(5) The gaming machine according to the above-mentioned (2), further comprising a second memory that stores identification data identifying a gaming machine installed in a game parlor,

wherein

the controller performs, in the processing (c), processing of converting the first sound data included in the extracted effect pattern data into second sound data including the specific data that shows a specific waveform corresponding to the identification data.

According to the invention of (5), since processing is performed in which the first sound data included in the effect pattern data is converted into second sound data including specific data that shows a specific waveform corresponding to identification data identifying a gaming machine installed in the game parlor, when a sound based upon the second sound data outputted from the speaker is inputted into an external device having a microphone, it is possible in the device to recognize from which device the sound has been outputted.

Further, the present invention provides the following.

(6) The gaming machine according to the above-mentioned (3),

wherein

the controller performs, in the processing (c), processing of converting the first sound data included in the extracted effect pattern data into second sound data including the specific data that shows a waveform of a specific inaudible sound.

According to the invention of (6), processing is performed in which the first sound data included in the effect pattern data is converted into second sound data including specific data that shows a waveform of a specific inaudible sound. When a sound based upon the second sound data outputted from the speaker is inputted into an external device having a microphone, it is determined in the device that part of a waveform shown by the sound signal outputted from the microphone includes the waveform that shows the specific inaudible sound, and a specific effect is executed. It is therefore possible to execute the effect without making the player aware of a change in sound outputted from the gaming machine.

Further, the present invention provides the following.

(7) The gaming machine according to the above-mentioned (3), further comprising a second memory that stores identification data identifying a gaming machine installed in a game parlor,

wherein

the controller performs, in the processing (c), processing of converting the first sound data included in the extracted effect pattern data into second sound data including the specific data that shows a specific waveform corresponding to the identification data.

According to the invention of (7), since processing is performed in which the first sound data included in the effect pattern data is converted into second sound data including specific data that shows a specific waveform corresponding to the identification data identifying a gaming machine installed in the game parlor, when a sound based upon the second sound data outputted from the speaker is inputted into an external device having a microphone, it is possible in the device to recognize from which device the sound has been outputted.

Further, the present invention provides the following.

(8) The gaming machine according to the above-mentioned (4), further comprising a second memory that stores identification data identifying a gaming machine installed in a game parlor,

wherein

the controller performs, in the processing (c), processing of converting the first sound data included in the extracted effect pattern data into second sound data including the specific data that shows a specific waveform corresponding to the identification data.

According to the invention of (8), since processing is performed in which the first sound data included in the effect pattern data is converted into second sound data including specific data that shows a specific waveform corresponding to identification data identifying a gaming machine installed in the game parlor, when a sound based upon the second sound data outputted from the speaker is inputted into an external device having a microphone, it is possible in the device to recognize from which device the sound has been outputted.

Further, the present invention provides the following.

(9) The gaming machine according to the above-mentioned (5), further comprising

an interface for inputting the identification data.

According to the invention of (9), since an interface (e.g. a USB terminal or a port for infrared communication) for inputting identification data is provided, it is possible to easily input or change the identification data.

Further, the present invention provides the following.

(10) The gaming machine according to the above-mentioned (7), further comprising

an interface for inputting the identification data.

According to the invention of (10), since an interface (e.g. a USB terminal or a port for infrared communication) for inputting identification data is provided, it is possible to easily input or change the identification data.

Further, the present invention provides the following.

(11) The gaming machine according to the above-mentioned (8), further comprising

an interface for inputting the identification data.

According to the invention of (11), since an interface (e.g. a USB terminal or a port for infrared communication) for inputting identification data is provided, it is possible to easily input or change the identification data.

Further, the present invention provides the following.

(12) A gaming machine comprising:

a microphone that converts an input sound from the outside into a sound signal and outputs the signal;

a third memory that stores normal effect pattern data and specific effect pattern data, as effect pattern data; and

a controller,

the controller programmed to execute the processing of

(a) determining whether or not a sound indicated by the sound signal outputted from the microphone includes a specific sound based upon specific data, and

(b) controlling execution of an effect based upon the normal effect pattern data when it is determined that the sound indicated by the sound signal outputted from the microphone does not include the specific sound based upon the specific data, and controlling execution of an effect based upon the specific effect pattern data when it is determined that the sound indicated by the sound signal outputted from the microphone includes the specific sound based upon the specific data.

According to the invention of (12), when it is determined that an input sound includes a specific sound based upon specific data, specific effect pattern data is extracted from a third memory (e.g. a ROM), and an effect is executed based upon the extracted effect pattern data. Therefore, with a plurality of such gaming machines installed in the game parlor, the sound outputted from the speaker provided in one gaming machine spreads therearound, and a specific effect is executed in a gaming machine installed around the gaming machine that has outputted the sound.

As thus described, according to the invention of (12), it is possible to produce a completely new effect where, when a sound including a specific sound is outputted from one gaming machine, a gaming machine around that gaming machine executes an effect as if it resonates. The effect involving another player in the game parlor can enhance vibrancy in the entire game parlor and expectation of a player who has not yet been able to satisfy the prescribed condition (e.g. has not yet hit a jackpot).

Further, since the specific effect is executed in a gaming machine different from the gaming machine that has outputted the sound, for example, a player who has been able to make the gaming machine output a sound including the specific sound by satisfying the prescribed condition (e.g. generating a special gaming state) can feel a sense of superiority.

Moreover, when a sound including the specific sound is outputted from one gaming machine, the sound is collected, and it is thus unnecessary to perform a wiring operation such as connection between the gaming machines or between the gaming machines and a management device. As thus described, since it is configured so as to produce an effect through sounds, the cost and time taken for investment in facilities can be reduced.

Further, the present invention provides the following.

(13) The gaming machine according to the above-mentioned (12),

wherein

the controller determines, in the processing (a), whether or not part of a waveform of the sound indicated by the sound signal outputted from the microphone includes a waveform identical or similar to a specific waveform based upon the specific data, and

controls, in the processing (b), execution of an effect based upon the normal effect pattern data when it is determined that part of a waveform of the sound indicated by the sound signal outputted from the microphone does not include a waveform identical or similar to the specific waveform based upon the specific data, and controls execution of an effect based upon the specific effect pattern data when it is determined that part of the waveform of the sound indicated by the sound signal outputted from the microphone includes a waveform identical or similar to the specific waveform based upon the specific data.

According to the invention of (13), when it is determined that part of a waveform of an input sound includes a waveform identical or similar to the specific waveform based upon the specific data, specific effect pattern data is extracted from the third memory (e.g. a ROM), and an effect is executed based upon the extracted effect pattern data. Therefore, according to the invention of (13), it is directly determined from the waveform whether or not the specific sound is included, thereby allowing prevention of malfunction.

Further, the present invention provides the following.

(14) The gaming machine according to the above-mentioned (13),

wherein

the specific waveform is a waveform with an amplitude in a specific frequency band different by a prescribed amount from a reference amplitude.

According to the invention of (14), since the specific waveform is a waveform with an amplitude in a specific frequency band different by a prescribed amount from a reference amplitude, for example, filter processing (e.g. band-pass filter processing that allows only a signal in a specific frequency band to pass) or the like may be performed, and it is thus possible to determine whether or not a sound is the specific sound by a relatively simple technique.

Further, the present invention provides the following.

(15) The gaming machine according to the above-mentioned (13),

wherein

the specific waveform is a waveform showing a specific inaudible sound.

According to the invention of (15), since the specific waveform is a waveform showing a specific inaudible sound, it is possible to execute the effect without making the player aware of a change in sound outputted from the gaming machine.

Further, the present invention provides the following.

(16) The gaming machine according to the above-mentioned (14),

wherein

the specific waveform is a waveform showing a specific inaudible sound.

According to the invention of (16), since the specific waveform is a waveform showing a specific inaudible sound, it is possible to execute the effect without making the player aware of a change in sound outputted from the gaming machine.

Further, the present invention provides the following.

(17) A gaming machine with a speaker capable of outputting a sound that is inputted into an external device having a microphone and that enables the device to execute a specific effect when it is determined in the device that the sound includes a specific voice based upon specific data, the gaming machine comprising:

a first memory that stores effect pattern data including first sound data;

a fourth memory that stores voice data; and

a controller,

the controller programmed to execute the processing of

(a) extracting the effect pattern data from the first memory,

(b) performing control to execute an effect, based upon the extracted effect pattern data,

(c) extracting voice data from the fourth memory,

(d) converting, as triggered by satisfaction of a prescribed condition, first sound data included in the effect pattern data extracted in the processing (a) into second sound data including the voice data extracted in the processing (c), and

(e) outputting from the speaker a sound based upon the processed second sound data.

According to the invention of (17), voice data is extracted from a fourth memory (e.g. a ROM) that stores voice data. As triggered by satisfaction of a prescribed condition, first sound data included in effect pattern data is converted into second sound data including the extracted voice data, and the data is outputted from the speaker. When the sound outputted from the speaker is inputted into an external device having a microphone, it is determined in the device that the sound includes the specific voice, and a specific effect is executed. It is therefore possible to execute an effect through the use of a voice having a complicated waveform.

Further, the present invention provides the following.

(18) A gaming machine comprising:

a microphone that converts an input sound from the outside into a sound signal and outputs the signal;

a voice recognition device that determines whether or not a sound indicated by the sound signal outputted from the microphone includes a specific voice based upon specific data;

a third memory that stores normal effect pattern data and specific effect pattern data, as effect pattern data; and

a controller,

the controller programmed to execute the processing of

(a) controlling execution of an effect based upon the normal effect pattern data when the voice recognition device does not recognize the specific voice, and controlling execution of an effect based upon the specific effect pattern data when the voice recognition device recognizes the specific voice.

According to the invention of (18), when it is determined that an input sound includes a specific voice based upon specific data, specific effect pattern data is extracted from a third memory (e.g. a ROM), and an effect is executed based upon the extracted effect pattern data. It is thus possible to execute an effect through the use of a voice having a complicated waveform.

### EFFECTS OF THE INVENTION

According to the present invention, it is possible to provide a gaming machine that is capable of producing a new effect in which contents of a game on one gaming machine are reflected to another gaming machine or the like in a game parlor, and of enhancing vibrancy in the entire game parlor and expectation of a player who has not yet hit a jackpot.

### BEST MODE FOR CARRYING OUT THE INVENTION

Embodiments of the present invention are described with reference to the drawings. First, the case of applying the present invention to a pachislo gaming apparatus is described as a first embodiment.

### First Embodiment

FIG. 1 is a perspective view schematically showing an example of a pachislo gaming apparatus according to the first embodiment of the present invention.

This pachislo gaming apparatus 1 is a gaming machine on which a game can be played using game media such as a card storing information on a game value that has been offered or will be offered to a player, in addition to coins, medals, tokens or the like; however, the case of using medals is described below.

A liquid crystal display 5 is installed on the front face of a cabinet 2 forming the entirety of the pachislo gaming apparatus 1. This liquid crystal display 5 has a transparent liquid crystal panel 34 (not shown). This transparent liquid crystal panel 34 is capable of switching part or the whole thereof to a transparent/opaque state, and also capable of displaying an effect image regarding a game.

Further, three rotational reels 3L, 3C, and 3R are provided on the rear surface side of the liquid crystal display 5. Each of the three rotational reels 3L, 3C, and 3R displays a plurality of pieces of identification information such as symbols on the outer peripheral surface thereof, and is rotatably provided in a horizontal row.

A base portion 10 having a horizontal surface is formed under the liquid crystal display 5. A medal insertion slot 22 is provided on the right side of the base portion 10. A 1-BET switch 11 and a maximum BET switch 13 are provided on the left side of the base portion 10.

On the left side of the front surface portion of the base portion 10 is provided an accumulated medal settlement switch 14 with which credit/payout of medals acquired in a game by the player is switched by a pressing operation.

When “Payout” is selected by switching of the accumulated medal settlement switch 14, medals are paid out from a medal payout exit 15 on the lower portion of the front surface, and the paid-out medals are accumulated in a medal receiving portion 16. On the other hand, when “Credit” is selected, the number of medals is stored as credits into a memory (e.g. a later-described RAM 43, or the like) in the pachislo gaming apparatus 1.

To the right side of the accumulated medal settlement switch 14, a start lever 6 for rotating the rotational reels 3L, 3C, and 3R by an operation by the player is installed rotatably in a prescribed angle range. Three stop buttons 7L, 7C, and 7R for respectively stopping rotation of the three rotational reels 3L, 3C, and 3R are provided at the center of the front surface portion of the base portion 10.

A determination button 26 and a cancel button 27 are provided on the right side of the front surface portion of the base portion 10. By operation of the determination button 26 or the cancel button 27, input of a command regarding switching of the display screen of the liquid crystal display 5, or the like, can be made.

A door opening-closing and shooting-stop-canceling device 29 is further provided on the right side of the front surface portion of the base portion 10. A prescribed key is inserted into a key hole of this door opening-closing and shooting-stop-canceling device 29, and is turned to the right so as to open/close the front door or turned to the left so as to cancel stopping of shooting.

Speakers 21L and 21R are provided on the right and left of the upper portion of the cabinet 2, and a payout table panel 23 showing winning symbols combinations, the numbers of payouts of medals, and the like, is provided between the two speakers 21L and 21R. In addition, a microphone 44 is provided on the right and left of the front of the cabinet 2.

FIG. 2 is an enlarged front view showing the neighborhood of the liquid crystal display in the pachislo gaming apparatus shown in FIG. 1.

As shown in FIG. 2, on the rear surface side of the liquid crystal display 5, the three rotational reels 3 (3L, 3C, 3R) with symbols as a plurality of pieces of identification information drawn on the respective outer peripheral surfaces thereof are rotatably provided in a horizontal row.

The liquid crystal display 5 includes a front panel 31 and the transparent liquid crystal panel 34 (not shown) provided on the rear surface of the front panel 31. The front panel 31 is comprised of a transparent display window 31a and a pattern-formed region 31b where patterns are drawn, and a screen image displayed to the transparent liquid crystal panel 34 provided on the rear surface of the front panel 31 is visible through the display window 31a of the front panel 31.

To the transparent liquid crystal panel 34 shown in FIG. 2, there is displayed a specific effect image 93 including fireworks images 93a and a notification image 93b notifying generation of a BB game on another pachislo gaming apparatus 1. This image is an image displayed when it is determined that a specific sound has been inputted from a microphone 44. In a game parlor installed with a plurality of pachislo gaming apparatuses 1, when a specific sound is outputted from a single pachislo gaming apparatus 1, a specific effect image is displayed simultaneously to other pachislo gaming apparatuses 1 installed within a prescribed range from the single pachislo gaming apparatus 1.

On the rear surface side on the left of the liquid crystal display 5, there are provided: a variety of lamps, i.e., a game start display lamp 25, a WIN lamp 17, a medal insertion lamp 24, a maximum BET lamp 9c, a 2-BET lamp 9b, and a 1-BET lamp 9a; and a variety of display portions, i.e., a number-of-payouts display portion 18, a number-of-accumulated-medals display portion 19, and a number-of-actuated-combinations display portion 20. It is to be noted that the pattern-formed region 31b of the front panel 31 is transparent in the front surface portions of the foregoing variety of lamps and variety of display portions, and the variety of lamps and the variety of display portions are thus visible.

The 1-BET lamp 9a, the 2-BET lamp 9b, and the maximum BET lamp 9c are lighted in accordance with the number of medals betted for playing one game (hereinafter also referred to as “the number of BETs”). One game ends when all the rotational reels are stopped or when medals are paid out in the case where payout of medals is to be conducted.

The WIN lamp 17 is lighted with a prescribed probability when BB (big bonus) or RB (regular bonus) is internally won, and is also lighted when winning of BB or RB is established. The medal insertion lamp 24 is flashed when insertion of medals is acceptable. The game start display lamp 25 is lighted when at least one line is activated.

The number-of-payouts display portion 18 displays the number of payouts of medals at the time of establishment of the winning; the number-of-accumulated-medals display portion 19 displays the number of accumulated medals; and the number-of-actuated-combinations display portion 20 displays the number of RB games possibly played, the number of RB games possibly won, and the like. These display portions are, for example, made up of seven-segment display.

FIG. 3 is a perspective view showing a schematic configuration of the liquid crystal display in the pachislo gaming apparatus shown in FIG. 1. FIG. 4 is an exploded view of a configuration of part of the liquid crystal display shown in FIG. 3.

The liquid crystal display 5 is comprised of: a front panel 31 including a protection glass 32 and a display board 33; the transparent liquid crystal panel 34; a light guiding plate 35; a reflection film 36; fluorescent lamps 37a, 37b, 38a, and 38b, which are so-called white light sources; lamp holders 39a to 39h; and table carrier package (TCP) loaded with an IC for driving a transparent liquid crystal panel. The TCP is made up of a flexible substrate (not shown) connected to a terminal portion of the transparent liquid crystal panel 34, or the like.

This liquid crystal display 5 is provided to the front side of the rotational reels 3L, 3C, and 3R. Further, these rotational reels 3L, 3C, and 3R and the liquid crystal display 5 are provided with prescribed spacing therebetween.

The protection glass 32 and the display board 33 are made of transparent materials. On the display board 33, patterns or the like are formed in positions corresponding to the BET lamps 9a to 9c, and in some other positions. That is, a region of the display board 33 where the patterns or the like are formed is the pattern-formed region 31b on the front panel 31, and a region of the display board 33 where the patterns or the like are not formed is the transparent display window 31a on the front panel 31 (c.f. FIG. 2). It is to be noted that the pattern-formed region 31b may not be formed on the front panel 31, and the whole area of the front panel 31 may be the transparent display window 31a. In this case, patterns may not be formed on the display board 33, or the display board 33 may be omitted.

In addition, an electric circuit and the like for activating the variety of lamps and the variety of display portions arranged on the rear surface side of the display board 33 are not shown.

The transparent liquid crystal panel 34 is formed by enclosing liquid crystal into a void portion between a transparent substrate such as a glass plate formed with a thin film transistor layer and a transparent substrate opposed thereto.

A display mode of this transparent liquid crystal panel 34 is set to normally white. Normally white is a configuration where liquid crystal is displayed white (light transmitted to the display surface side is visible from the outside) in a state where the liquid crystal is not driven. Adoption of the transparent liquid crystal panel 34 configured to be normally white can make variable display and stop-display of identification information such as symbols, displayed on the rotational reels 3L, 3C, and 3R, visible even when a situation occurs where the liquid crystal cannot be driven, so as to allow continuation of a game. That is, even in the case of occurrence of such a situation, a game can be played mainly in the variable display mode and the stop-display mode of the identification information displayed on the rotational reels 3L, 3C, and 3R.

The light guiding plate 35 serves to guide light from the fluorescent lamps 37a and 37b to the transparent liquid crystal panel 34 (illuminate the transparent liquid crystal panel 34). The light guiding plate 35 is provided on the rear side of the transparent liquid crystal panel 34, and made up of, for example, a transparent member (having a light guiding function), such as an acrylic resin, having a thickness of about 2 cm.

As the reflection film 36, for example, a film is used which has been obtained by forming an evaporated silver film on a white polyester film or an aluminum thin film, and the reflection film 36 reflects light guided into the light guiding plate 35 toward the front surface side of the light guiding plate 35. This reflection film 36 is comprised of a reflection region 36A and non-reflection region (transmission region) 36B.

The fluorescent lamps 37a, 37b are respectively arranged along the top end and the bottom end of the light guiding plate 35, and both ends of the lamps are supported by the lamp holders 39 (cf. FIG. 3). Light applied from these fluorescent lamps 37a, 37b is reflected on the reflection region 36A of the reflection film 36, and illuminates the transparent liquid crystal panel 34.

The fluorescent lamps 38a, 38b are respectively arranged on the upper position and the lower position of the rear side of the reflection film 36, toward the rotational reels 3L, 3C, and 3R. Light applied from these fluorescent lamps 38a, 38b is reflected on the front surfaces of the rotational reels 3L, 3C and 3R, and falls on the non-reflection region 36B, thereby illuminating the transparent liquid crystal panel 34.

As thus described, in the liquid crystal display 5, the light applied from the fluorescent lamps 37a, 37b, which is reflected on the reflection region 36A of the reflection film 36, and the light applied from the fluorescent lamps 38a, 38b, which is reflected on the front surfaces of the rotational reels 3L, 3C and 3R and falling on the non-reflection region 36B, illuminate the transparent liquid crystal panel 34.

Therefore, the region of the liquid crystal display 5 which corresponds to the non-reflection region 36B of the reflection film 36 is a region where switching of transparent/opaque states is made depending upon whether or not the liquid crystal has been driven. The region of the liquid crystal display which corresponds to the reflection region 36A of the reflection film 36 comes into an opaque state irrespective of whether or not the liquid crystal has been driven.

In the pachislo gaming apparatus 1, only part of the region of the liquid crystal display is a region where switching of transparent/opaque states is made. However, in the gaming machine of the present invention, the whole region of the display screen of the liquid crystal display may be a region where switching of transparent/opaque states is made. In this case, when the whole region of the liquid crystal display 5 is made a region where switching of transparent/opaque states is made in the pachislo gaming apparatus 1, the entirety of the reflection film 36 may be provided as the non-reflection region 36B, or the reflection film 36 may be omitted.

FIG. 5 is a block diagram showing an internal configuration of the pachislo gaming apparatus shown in FIG. 1.

A main control circuit 81 mainly includes a microcomputer 40 arranged on a circuit board. The microcomputer 40 includes: a CPU 41 that performs a control operation in accordance with a previously set program; a ROM 42; and a RAM 43. The microcomputer 40 corresponds to the controller in the present invention. The CPU 41 is connected with a clock pulse generation circuit 144 and a frequency divider 145 that set a reference clock pulse, and a random number generator 146 and a sampling circuit 147 that generate a random number to be sampled. It may be configured such that, as means for random number sampling, the random number sampling is executed on an operation program of the CPU 41.

The ROM 42 stores a variety of control commands to be transmitted to a sub control circuit 82, and the like. As the commands, for example, a command regarding display-control over the liquid crystal display 5, a command regarding voice output control over the speakers 21, and some other commands are stored.

Examples of the command regarding control over the liquid crystal display 5 and the speakers 21 may include an effect start command and an end effect command.

The effect start command is a command to the liquid crystal display 5 for displaying an effect image at the start of rotation of the three rotational reels 3 (3L, 3C, 3R), and to the speakers 21 for outputting a voice regarding the effect. The end effect command is a command to the liquid crystal display 5 for displaying an effect image at the stop of rotation of all of the three rotational reels 3 (3L, 3C, 3R), and to the speakers 21 for outputting a voice regarding the end effect.

Further, commands regarding setting or cancel of RB, BB are also stored in the ROM 42, and by these commands, setting or cancel of RB or BB is notified to the sub control circuit 82. It should be noted that in place of the command regarding setting or cancel of RB or BB, data indicating that RB or BB is in execution may be included in the variety of commands regarding display-control to the liquid crystal display 5.

The variety of commands as described above are called from the ROM 42 by the CPU 41 as triggered by establishment of a prescribed condition, to be set in the RAM 43. The command set in the RAM 43 is then supplied to the sub control circuit 82 at a prescribed timing. The sub control circuit 82 executes a variety of processing based upon the supplied command. It is to be noted that communication is performed in one direction from the main control circuit 81 to the sub control circuit 82, without input of a command or the like by the sub control circuit 82 to the main control circuit 81.

Further, the ROM 42 stores a symbol table for making rotational positions of the rotational reels 3L, 3C, and 3R correspond to the symbols drawn on the outer peripheral surfaces of the rotational reels. Moreover, the ROM 42 stores a winning symbol-combination table where combinations of symbols as winning, the numbers of payouts of medals for winning, and winning determination codes representing the respective winnings are corresponded to one another, a lottery probability table necessary for performing a lottery to determine an internal winning combination, and the like.

Other than the foregoing commands, the RAM 43 stores, for example, a variable, a flag and the like relating to game progressions, such as the number of credits corresponding to the number of medals and a set value.

Examples of main peripheral devices (actuators), whose operations are controlled by control signals from the microcomputer 40, may include: a variety of lamps (1-BET lamp 9a, 2-BET lamp 9b, maximum BET lamp 9c, WIN lamp 17, medal insertion lamp 24, game start display lamp 25, illumination lamp 93); a variety of display portions (number-of-payouts display portion 18, number-of-accumulated-medals display portion 19, number-of-actuated-combinations display portion 20); a hopper (including a driving portion for payout) 50 that houses medals and pays out a prescribed number of medals in accordance with a command from a hopper driving circuit 51; and stepping motors 59L, 59C, and 59R which rotationally drive the rotational reels 3L, 3C, and 3R.

Moreover, an output portion of the CPU 41 is connected through an I/O port 48 with a motor driving circuit 49 that drive controls the stepping motors 59L, 59C, and 59R, a hopper driving circuit 51 that drive controls the hopper 50, a lamp driving circuit 55 that drive controls a variety of lamps, and a display portion driving circuit 58 that drive controls a variety of display portions. Upon receipt of a control signal such as a driving command outputted from the CPU 41, each of those driving circuits controls the operation of each actuator.

Further, main input signal generators that generate an input signal necessary for generation of a control command by the microcomputer 40 are the start switch 6S, the 1-BET switch 11, the maximum BET switch 13, the accumulated medal settlement switch 14, an inserted medal sensor 22S, a reset switch 62, a key-shaped switch 63 for setting, a reel stop signal circuit 56, a reel position detection circuit 60, and a payout completion signal circuit 61. These are also connected to the CPU 41 through the I/O port 48. The key-shaped switch 63 for setting serves such that a prescribed key is inserted into a key hole thereof and turned to the right or left to allow a change in setting of a set value.

The start switch 6S detects an operation of the start lever 6. The inserted medal sensor 22S detects a medal inserted into the medal insertion slot 22. The reel stop signal circuit 56 generates a stop signal in accordance with an operation of each of the stop buttons 7L, 7C, and 7R. Operating the determination button 26 and the cancel button 27 enables switching of the display screen of the liquid crystal display 5, input of a command, and the like.

Upon receipt of a pulse signal from a reel rotation sensor, the reel position detection circuit 60 transmits signals for detecting the positions of the respective rotational reels 3L, 3C, and 3R, to the CPU 41.

When a count value (the number of medals paid out from the hopper 50) of the medal detecting portion 50S reaches a designated number of medals, the payout completion signal circuit 61 generates a medal payout completion signal. Upon receipt of this medal payout completion signal, the CPU 41 stops driving of the hopper 50 through the hopper driving circuit 51, to complete payout of medals. This medal detecting portion 50S has a medal sensor comprised of a physical sensor or the like for detecting medals paid out from the hopper 50, and can thus count the number of payouts of medals by using this medal sensor.

In the circuit shown in FIG. 5, the random number generator 146 generates random numbers belonging to a set numeric value range, and the sampling circuit 147 samples one random number at an appropriate timing after operation of the start lever 6. Based upon the random number sampled in this manner and the lottery probability table stored inside the ROM 42, an internal winning combination is determined. After the determination of the internal winning combination, a random number is sampled again for selecting a “stop control table”.

After the start of rotation of the rotational reels 3L, 3C, and 3R, the numbers of drive pulses supplied to the stepping respective motors 59L, 59C, and 59R are counted, and the count values are written in a prescribed area of the RAM 43. Reset pulses are obtained from the rotational reels 3L, 3C, and 3R in each rotation, and these pulses are inputted into the CPU 41 through the reel position detection circuit 60. By the reset pulses as thus obtained, the count values of the drive pulses counted in the RAM 43 are cleared to “0”. In this manner, the count values corresponding to the respective rotational positions of the reels 3L, 3C, and 3R within the range of one rotation are stored in the RAM 43.

In order to make the rotational positions of the rotational reels 3L, 3C, and 3R as described above correspond to the symbols drawn on the outer peripheral surfaces of the rotational reels, the symbol table is stored in the ROM 42. In this symbol table, with the rotational position where the foregoing reset pulse is generated as a reference, code numbers sequentially granted at each set rotational pitch of the rotational reels 3L, 3C, and 3R are corresponded to symbol codes indicating symbols provided in association with the respective code numbers.

Moreover, the winning symbol-combination table is stored in the ROM 42. In this winning symbol-combination table, winning combinations of symbols, the numbers of payouts of medals for winning, and winning determination codes representing the winning are corresponded to one another. The above winning symbol-combination table is referenced when the left rotational reel 3L, the central rotational reel 3C, and the right rotational reel 3R are stop-controlled and when winning is checked after the stop of all of the reels.

In the case of internal winning by lottery processing (probability lottery processing) based upon the random number sampling, the CPU 41 transmits a signal for stop-controlling the rotational reels 3L, 3C, and 3R to the motor driving circuit 49, based upon operation signals transmitted from the reel stop signal circuit 56 at a timing when the player operates the stop buttons 7L, 7C, and 7R, and the selected “stop control table”.

In the case of the mode coming into a stop mode showing establishment of the internally won combination, when “Payout” has been selected by switching of the accumulated medal settlement switch 14, the CPU 41 supplies a payout command signal to the hopper driving circuit 51, to pay out a prescribed number of medals from the hopper 50. At this time, the medal detecting portion 50S counts the number of medals that are paid out from the hopper 50, and when the count value reaches a designated number, a medal payout completion signal is inputted into the CPU 41. By doing so, the CPU 41 stops the drive of the hopper 50 through the hopper driving circuit 51, to complete the “medal payout processing”.

On the other hand, when “Credit” has been selected by switching of the accumulated medal settlement switch 14, the number of medals to be paid out is stored, as credits, into the RAM 43.

The main control circuit 81 having the CPU 41 therein is connected with the sub control circuit 82.

The sub control circuit 82 performs display-control of the liquid crystal display 5 and output-control of a sound from the speakers 21L, 21R, based upon a control command from the main control circuit 81.

FIG. 6 is a block diagram showing a configuration of the sub control circuit shown in FIG. 5.

Although it is configured in the present embodiment such that a command is supplied from the main control circuit 81 to the sub control circuit 82 while a signal is prevented from being supplied from the sub control circuit 82 to the main control circuit 81, the configuration is not limited to this, and it may be configured such that a signal can be transmitted from the sub control circuit 82 to the main control circuit 81.

The sub control circuit 82 has a sub CPU 206, a program ROM 208 and a work RAM 210. Further, the sub control circuit 82 is connected with the determination button 26 and the cancel button 27, through an interface circuit 240.

Further, the sub control circuit 82 has a display-control circuit 250 that performs display-control on the liquid crystal display 5, and a voice control circuit 230 that performs control regarding a sound generated from the speakers 21.

The sub CPU 206 has the function of executing a variety of processing, such as processing relating to an effect, in accordance with programs stored in the program ROM 208, and controls the sub control circuit 82 in accordance with a variety of commands supplied from the CPU 41.

Programs for the sub CPU 206 to control gaming effects on the liquid crystal display 5 and the speakers 21 are stored into the program ROM 208, and besides those programs, a variety of tables such as a table for making a determination regarding the effects are also stored.

Moreover, the program ROM 208 stores: a plurality of kinds of effect pattern data corresponded to screen images displayed to the liquid crystal display 5 as well as a sound outputted from the speakers 21; and a plurality of kinds of end effect pattern data corresponded to screen images displayed, as well as a voice outputted, at the stop of all of the reels 3 (3L, 3C, 3R). The program ROM 208 corresponds to the first memory that stores effect pattern data.

Further, the program ROM 208 stores comparison waveform data as an object to be compared with a waveform shown by a sound signal outputted from the microphone 44. The sub CPU 206 compares output waveform data generated based upon the sound signal outputted from the microphone 44 with the comparison waveform data, to determine whether or not waveforms shown by the respective waveform data are identical or similar to each other.

Further, the sub control circuit 82 is connected with the microphone 44 that converts an input sound from the outside into a sound signal and outputs the signal, through a signal processing circuit 44a. The signal processing circuit 44a includes a variety of circuits such as an AGC circuit and an A/D conversion circuit, and performs a variety of processing for converting a sound signal outputted from the microphone 44 into output waveform data. The AGC circuit automatically controls an amplification factor of an amplifier provided inside thereof so as to obtain a fixed output even when a magnitude of an input sound signal fluctuates.

Further, the sub control circuit 82 is connected with an interface 92 for data input for inputting identification data of the pachislo gaming apparatus 1. The identification data inputted from the interface 92 for data input is stored in the work RAM 210. In the present invention, the identification data is not particularly limited, and examples thereof may include a number and a symbol provided independently by the game parlor, an identification number that identifies the pachislo gaming apparatus 1, the number being uniquely set to a pachislo gaming apparatus, and the like.

Examples of the interface 92 for data input include a USB (Universal Serial Bus) port and an RS-232C port, but in the present invention, the interface 92 for data input is not particularly limited so long as being connectable to an external device. Although the case of inputting identification data by wire connection is described in the present embodiment, the present invention is not limited thereto. For example, wireless connection, such as connection by infrared communication, may be adopted.

In addition, although it is configured in the present embodiment such that the program ROM 208 is used as a storage medium for storing programs, tables, and the like, the configuration is not limited thereto. The storage medium may be in a different mode so long as being a storage medium readable by a computer having a CPU and the like, and recording may be made, for example, in a hard disc device or storage media such as a CD-ROM, a DVD-ROM or a ROM cartridge. Naturally, what is stored in the program ROM 208 may be stored in the ROM 42. Further, these programs may not be previously recorded, but may be downloaded after switch-on of power, and recorded in the work RAM 210 or the like. Moreover, each of the programs may be recorded in different storage media.

Furthermore, in the present embodiment, the main control circuit 81 including the CPU 41 and the ROM 42 therein and the sub control circuit 82 including the sub CPU 206 and the program ROM 208 therein are separately configured, but the configuration is not limited thereto. Only the main control circuit 81 including the CPU 41 and the ROM 42 therein may constitute the circuit, and in this case, it should be configured such that programs stored in the foregoing program ROM 208 are stored into the ROM 42 and executed by the CPU 41. Naturally, only the sub control circuit 82 including the sub CPU 206 and the program ROM 208 therein may constitute the circuit, and in this case, it should be configured such that programs stored in the foregoing ROM 42 are stored into the program ROM 208 and executed by the sub CPU 206.

The work RAM 210 has the function of storing a variety of flags and variable values, as a temporary storage region of the sub CPU 206. In particular, the work RAM 210 stores identification data inputted from the interface 92 for data input. The work RAM 210 corresponds to the second memory that stores identification data. It is to be noted that, although the work RAM 210 is used as the temporary storage region of the sub CPU 206 in the present embodiment, the temporary storage region is not limited thereto, and may be any storage media so long as being readable and writable media.

Moreover, the voice control circuit 230 is comprised of a sound source IC 232 that performs control regarding a voice, a voice data ROM 234 that stores a variety of sound data, and an amplifier 236 (hereinafter referred to as “AMP”) for amplifying a sound signal.

The sound source IC 232 is connected with the sub CPU 206, the voice data ROM 234, and the AMP 236. The voice data ROM 234 stores a plurality of kinds of sound data. The sound data includes, for example, sound data regarding an effect (hereinafter referred to as “first sound data”), and an inaudible sound data indicating an inaudible sound that is outputted as triggered by generation of BB. The inaudible sound data corresponds to the specific data in the present invention.

FIGS. 7 (a) to 7 (c) are diagrams for describing sound data stored in the voice data ROM. FIG. 7 (a) is a diagram showing a waveform shown by the first sound data, FIG. 7 (b) is a diagram showing a waveform shown by the inaudible sound data, and FIG. 7 (c) is a diagram showing a waveform shown by second sound data synthesizing the first sound data with the inaudible sound data. It is to be noted that in the figure, “f0” denotes a frequency as a boundary between audible and inaudible sounds, and “f1” denotes a center frequency of the inaudible sound indicated by the inaudible sound data.

Upon receipt of supply of effect pattern data, the sound source IC 232 reads the first sound data from the voice data ROM 234. For example, the sound source IC 232 reads the first sound data showing the waveform shown in FIG. 7(a).

Further, the sound source IC 232 reads inaudible sound data from the voice data ROM 234 when receiving supply of effect pattern data for BB. For example, the sound source IC 232 reads inaudible sound data showing the waveform shown in FIG. 7(b). A plurality of pieces of inaudible sound data are stored in the voice data ROM 234, and the sound source IC 232 references identification data stored in the work ROM 210 and reads inaudible sound data corresponding to the identification data of the pachislo gaming apparatus 1. That is, for example, the inaudible sound data showing the waveform shown in FIG. 7(b) is read when a BB game is generated on this pachislo gaming apparatus 1, while, when a BB game is generated in another pachislo gaming apparatus 1, inaudible sound data is read which is different from the inaudible sound data showing the waveform shown in FIG. 7 (b) (inaudible sound data showing a waveform with a center frequency different from “f1”).

Moreover, the sound source IC 232 synthesizes the first sound data with the inaudible sound data, to convert the data into the second sound data. For example, the sound source IC 232 converts the data into the second sound data showing the waveform shown in FIG. 7(c).

Furthermore, the sound source IC 232 converts the first sound data or the second sound data into a prescribed sound signal and supplies the sound signal to the AMP 236. The AMP 236 amplifies the sound signal and outputs a sound from the speakers 21 (21L and 21R). Therefore, in another pachislo gaming apparatus 1 into which the sound has been inputted, it is determined, based upon an inaudible sound included in the sound, which pachislo gaming apparatus 1 has identification data that the specific sound is based on.

The display-control circuit 250 generates a screen image in accordance with a game result determined by the CPU 41 or a command inputted from the variety of buttons 26 and 27, and controls to display the screen image to the liquid crystal display 5. The display-control circuit 250 is configured of an image data processor (hereinafter referred to as “VDP”) 212, an image data ROM 216 that stores a variety of image data, and a D/A converter 218 that converts image data into an image signal. The VDP 212 is connected with the sub CPU 206, the image data ROM 216 that stores image data, and the D/A converter 218 that converts image data into an image signal.

This VDP 212 is a device which includes a variety of circuits such as so-called a sprite circuit, a screen circuit, and a palette circuit, and is capable of performing a variety of processing for displaying a screen image to the liquid crystal display 5. That is, the VDP 212 performs display-control over the liquid crystal display 5. Further, the VDP 212 is provided with a storage medium (e.g. video RAM) as a buffer for displaying a screen image to the transparent liquid crystal panel 34 of the liquid crystal display 5. By storing image data in a prescribed storage region of this storage medium, a screen image is displayed to the transparent liquid crystal panel 34 of the liquid crystal display 5 at a prescribed timing.

The image data ROM 216 stores a plurality of kinds of effect image data. The effect image data is classified into normal effect image data and specific effect image data. Examples of the effect image data (normal effect image data and specific effect image data) include background image data that constitutes a background image, and character image data that represents a character. The image data ROM 216 corresponds to the third memory that stores the normal effect pattern data and the specific effect pattern data. The specific effect image data is image data regarding an image that is displayed only when a specific sound is inputted from the microphone 44 (e.g. the fireworks image 93a and the notification image 93b shown in FIG. 2). The normal effect image data is image data regarding an image that is displayed when a specific sound has not been inputted from the microphone 44.

The VDP 212 extracts an effect image from the image data ROM 216 in accordance with an image display command supplied from the sub CPU 206.

The VDP 212 superimposes a variety of images extracted from the image data ROM 216, sequentially from an image located on the back, e.g. in a sequence of the background image and the character image, to store them in the buffer (e.g. video RAM or the like), so as to synthesize a screen image. The VDP 212 then supplies the synthesized image to the D/A converter 218 at a prescribed timing. The D/A converter 218 converts this screen image into an image signal and supplies this image signal to the liquid crystal display 5.

In the following, it is assumed that the pachislo gaming apparatus 1 has been activated and steadily operated in a state where a variable used in the CPU 41 is initialized to a prescribed value, and a set value, a variety of timers, and the like are also set to prescribed values.

FIG. 8-1 and FIG. 8-2 are flowcharts showing a subroutine of processing performed in the main control circuit. This subroutine is called at a prescribed timing from a previously executed main routine and then executed.

First, the CPU 41 determines whether or not a request for automatic medal insertion has been made (step S120). It is to be noted that the case where the request for automatic insertion has been made is a case where winning for replay has been established in a previous game. When the request for automatic medal insertion has been made, the CPU 41 automatically inserts medals in number requested (step S122), and transmits a medal insertion command to the sub control circuit 82 (step S123).

On the other hand, when determining in step S120 that the request for automatic medal insertion has not been made, the CPU 41 determines whether or not medals have been inserted (step S121). That is, the CPU 41 determines whether or not medals have been inserted, by determining whether or not a detection signal has been received which is issued by the inserted medal sensor 22S that has detected insertion of medals into the medal insertion slot 22, or by determining whether or not a detection signal has been received which is issued from the BET switch (1-BET switch 11 or maximum BET switch 13). It should be noted that, when determining that the detection signal issued from the BET switch (1-BET switch 11 or maximum BET switch 13) has been received, the CPU 41 performs processing of subtracting the number of credits corresponding to the number of betted medals from the number of credits stored in the RAM 43.

When determining in step S121 that medals have not been inserted, the CPU 41 returns the processing to step S120.

Further, when determining in step S121 that medals have been inserted, or when executing the processing of step S123, the CPU 41 determines whether or not the start lever 6 has been operated (step S124). That is, the CPU 41 determines whether or not an input signal has been received from the start switch 6S.

When determining in step S124 that the start lever 6 has not been operated, the CPU 41 returns the processing to step S120. On the other hand, when determining in step S124 that the start lever 6 has been operated, the CPU 41 performs processing in accordance with a variety of settings (step S125). In this variety-of-setting processing, random numbers from the random number generator 146 are sampled at a timing of operation of the start lever 6, and lottery processing of generating internal winning combination (winning flag) is conducted based upon the sampled random number value and the lottery probability table set in the RAM 43. Further, in this variety-of-setting processing, for example, WIN lamp lightning lottery processing, processing in accordance with selection of the stop control table for stopping the rotational reels, processing of initialization for the reel rotation, and the like, are performed, and rotation of the rotational reels 3 (3L, 3C, 3R) is started.

After the start of rotation of the rotational reels 3L, 3C, and 3R, the numbers of drive pulses transmitted to the respective stepping motors 59L, 59C, and 59R are counted, and the count values are stored in the RAM 43. A reset pulse is obtained from the rotational reels 3L, 3C, and 3R in each rotation, and these pulses are inputted into the CPU 41 through the reel position detection circuit 60. By the reset pulses as thus obtained, the count values of the drive pulses counted in the RAM 43 are cleared to “0”. In this manner, the count values corresponding to the rotational positions within the range of one rotation of the rotational reels 3L, 3C, and 3R are stored in the RAM 43.

Further, in the symbol table stored in the ROM 42 for making the rotational positions of the rotational reels 3L, 3C, and 3R correspond to symbols drawn on the outer peripheral surfaces of the rotational reels, with the rotational positions where the foregoing reset pulse is generated as a reference, code numbers sequentially granted at a set rotational pitch of each of the rotational reels 3L, 3C, and 3R are associated with symbol codes indicating symbols provided corresponding to the respective code numbers. Further, the winning symbol-combination table stored in the ROM 42 is referenced when the rotational reels 3L, 3C, and 3R are stop-controlled and when winning is checked after the stop of all of the rotational reels.

After executing the processing of step S125, the CPU 41 shifts the processing to step S126.

In step S126, the CPU 41 sets an effect start command in the RAM 43. This effect start command is a command for starting display of a prescribed effect image to the liquid crystal display 5 and starting output of a prescribed voice from the speakers 21, and includes data regarding the internal winning combination determined in the above lottery processing. The effect start command is supplied to the sub control circuit 82 at a prescribed timing.

After executing the processing of step S126, the CPU 41 shifts the processing to step S128.

In step S128, the CPU 41 determines whether or not the stop buttons 7 (7L, 7C, 7R) have been turned “ON” by the presence or absence of an input signal from the reel stop signal circuit 56 (step S128). When determining that the stop button 7 has not been turned “ON”, the CPU 41 determines whether or not a value of the automatic stop timer is “0” (step S129). When determining that the value of the timer is not “0”, the CPU 41 returns the processing to step S128.

On the other hand, when determining in step S128 that the stop button 7 has been turned “ON”, or when determining in step S129 that the value of the automatic stop timer is “0”, the CPU 41 stops rotation of the rotational reel 3 corresponding to the stop button 7. At this time, the number of sliding frames is determined based upon a winning request (meaning an internal winning combination), symbol positions (rotational positions of the rotational reels 3 at the time of operation), a stop control table selected, and the like (step S130).

Next, the CPU 41 performs processing of rotating and stopping the rotational reels 3 by the number of sliding frames determined in step S130 (step S131), and sets a stop request regarding one rotational reel 3 (step S132).

Next, the CPU 41 determines whether or not all of the three rotational reels 3 (3L, 3C, 3R) have stopped (step S135). When determining that all of the rotational reels 3 have not stopped, the CPU 41 returns the processing to step S128. On the other hand, when determining that all of the rotational reels 3 have stopped, the CPU 41 performs a winning search (step S136). At this time, the winning symbol-combination table stored in the ROM 42 or the like is referenced. Further, the CPU 41 may determine whether or not the winning flag is normal, and may display an illegal error and discontinue the processing when determining that the flag is not normal.

Next, the CPU 41 sets an end effect command in the RAM (step S137). This end effect command is a command for displaying an effect image and outputting a voice at the game ending time in accordance with a game result, and includes data regarding a result of the winning search in step S136. The end effect command is supplied to the sub control circuit 82 at a prescribed timing.

Next, the CPU 41 determines whether or not medals will be paid out, namely, the presence or absence of the number of medals for winning (step S138).

When determining that medals will be paid out, the CPU 41 accumulates or pays out medals in number in accordance with the gaming state and the winning combination (step S139). In the case of accumulating medals, the CPU 41 performs processing of addition to the number of credits stored in the RAM 43. On the other hand, in the case of paying out medals, the CPU 41 transmits a payout command signal to the hopper driving circuit 51, to pay out a prescribed number of medals from the hopper 50. At this time, the medal detecting portion 50S counts the number of medals paid out from the hopper 50, and when the count value reaches a designated number, a medal payout completion signal is inputted into the CPU 41. By doing so, the CPU 41 stops driving of the hopper 50 through the hopper driving circuit 51 and completes the medal payout processing.

Next, the CPU 41 determines whether or not RB has been won (step S140). When determining that RB has been won, the CPU 41 performs processing in accordance with setting of RB (step S141). In this step S141, the CPU 41 performs processing in accordance with setting of a lottery probability table for RB and a winning symbol-combination table for RB. Further, in this step S141, the CPU 41 starts counting of the number of times of winning of RB games and the like, and starts processing of displaying the count value to the number-of-actuated-combinations display portion 20. After executing the processing of step S141, the CPU 41 shifts the processing to step S142.

In step S142, the CPU 41 sets an RB setting command in the RAM 43. The RB setting command is a command for displaying the effect image for RB, as the screen image, to the liquid crystal display 5 and outputting a voice in accordance with RB from the speakers 21, and is supplied to the sub control circuit 82 at a prescribed timing.

When determining in step S140 that RB has not been won, or when executing processing of step S142, the CPU 41 determines whether or not BB has been won (step S143). When determining that BB has been won, the CPU 41 performs processing in accordance with setting of BB (step S144). In this step S144, the CPU 41 performs processing in accordance with setting of a lottery probability table for BB, a winning symbol-combination table for BB, and the like. Further, in step S144, the CPU 41 starts counting of the number of times of BB games played or the like, displaying the count value to the number-of-actuated-combinations display portion 20, counting the number of paid-out medals, and the like. Thereafter, the CPU 41 shifts the processing to step S145.

In step S145, the CPU 41 sets a BB setting command in the RAM 43. The BB setting command is a command for displaying the effect image for BB, as the screen image, to the liquid crystal display 5 and outputting a voice in accordance with BB from the speakers 21, and is supplied to the sub control circuit 82 at a prescribed timing.

When determining in step S143 that BB has not been won, or when executing the processing of step S145, the CPU 41 determines whether or not RB has ended (step S146). When determining that RB has ended, the CPU 41 then performs processing in accordance with canceling of setting of RB (step S147). In step S148, the CPU 41 performs processing in accordance with a change in setting from the lottery probability table for RB, the winning symbol-combination table for RB, and the like, which have been set in step S141, to the lottery probability table for use in a normal gaming state (other than RB or BB). Thereafter, the CPU 41 shifts the processing to step S148.

In step S148, the CPU 41 sets an RB cancel command in the RAM 43. The RB cancel command is supplied to the sub control circuit 82 at a prescribed timing.

When not determining in step S146 that RB has ended, or when executing the processing of step S148, the CPU 41 determines whether or not BB has ended (step S149). When determining that BB has ended, the CPU 41 then performs processing in accordance with canceling of setting of BB (step S150). In step S150, the CPU 41 performs processing in accordance with a change in setting from the lottery table for BB, the winning symbol-combination table for BB, and the like, which have been set in step S144, to the lottery probability table for use in the normal gaming state (other than RB or BB). Thereafter, the CPU 41 shifts the processing to step S151.

In step S151, the CPU 41 sets a BB cancel command in the RAM 43. The BB cancel command is supplied to the sub control circuit 82 at a prescribed timing.

When determining in step S149 that RB has not ended, or when executing the processing of step S151, the CPU 41 completes the present subroutine.

FIG. 9 is a flowchart showing a subroutine of sound recognition processing performed in the sub control circuit.

First, in step S180, the sub CPU 206 receives output waveform data generated based upon an input sound inputted from the microphone 44, from the signal processing circuit 44a.

Next, the sub CPU 206 references comparison waveform data stored in the program ROM 208 (step S181), and determines whether or not part of a waveform shown by the output waveform data includes a waveform identical or similar to a specific waveform shown by the comparison waveform data (step S182). In the processing, the sub CPU 206 determines whether or not the compared waveforms are identical or similar to each other based upon a similarity obtained by a prescribed calculation formula.

When it is determined that part of the waveform shown by the output waveform data (the prescribed inaudible frequency band portion in the present embodiment) does not include a waveform identical or similar to the specific waveform shown by the comparison waveform data (step S182: NO), the present subroutine is completed. On the other hand, when it is determined that part of the waveform shown by the output waveform data includes a waveform identical or similar to the specific waveform shown by the comparison waveform data (step S182: YES), the sub CPU 206 sets a specific sound detection flag in step S183. After execution of the processing of step S183, the present subroutine is completed. It is to be noted that the specific sound detection flag is a flag that indicates detection of the specific sound, and a flag that is cleared after the lapse of a prescribed period after setting.

FIG. 10 is a flowchart showing a subroutine of command receiving processing performed in the sub control circuit.

First, in step S200, the sub CPU 206 determines whether or not an effect start command has been received. When determining that the effect start command has not been received, the sub CPU 206 shifts the processing to step S210. On the other hand, when determining that the effect start command has been received, the sub CPU 206 shifts the processing to step S201.

In step S201, the sub CPU 206 determines whether or not a specific sound detection flag has been set. When determining that the specific sound detection flag has been set, the sub CPU 206 selects an effect pattern corresponding to the command, out of specific effect patterns (step S202). The sub CPU 206 selects a specific effect pattern for RB when an RB flag has been set. Further, the sub CPU 206 selects a specific effect pattern for BB when a BB flag has been set.

On the other hand, when determining that the specific sound detection flag has not been set, the sub CPU 206 selects an effect pattern corresponding to the command, out of specific effect patterns (step S203). The sub CPU 206 selects a normal effect pattern for RB when the RB flag has been set. Further, the sub CPU 206 selects a normal specific effect pattern for BB when the BB flag has been set.

Next, in step S204, the sub CPU 206 supplies effect pattern data as data showing an effect pattern, to the display control circuit 250 and the voice control circuit 230. After executing the processing of step S204, the sub CPU 206 shifts the processing to step S210.

In step S210, the sub CPU 206 determines whether or not an end effect command has been received. When determining that the end effect command has not been received, the sub CPU 206 shifts the processing to step S220. On the other hand, when determining that the end effect command has been received, the sub CPU 206 shifts the processing to step S211.

In step S211, the sub CPU 206 determines whether or not a specific sound detection flag has been set. When determining that the specific sound detection flag has been set, the sub CPU 206 selects an effect pattern corresponding to the command, out of end specific effect patterns (step S212). The sub CPU 206 selects an end specific effect pattern for RB when the RB flag has been set. Further, the sub CPU 206 selects an end specific effect pattern for BB when the BB flag has been set.

On the other hand, when determining that the specific sound detection flag has not been set, the sub CPU 206 selects an effect pattern corresponding to the command, out of end normal effect patterns (step S213). The sub CPU 206 selects an end normal effect pattern for RB when the RB flag has been set. Further, the sub CPU 206 selects an end normal specific effect pattern for BB when the BB flag has been set.

Next, in step S214, the end effect pattern data is supplied to the display control circuit 250 and the voice control circuit 230. After executing the processing of step S210, the sub CPU 206 shifts the processing to step S220.

In step S220, the sub CPU 206 determines whether or not an RB setting command has been received. When determining that the RB setting command has not been received, the sub CPU 206 shifts the processing to step S230. On the other hand, when determining that the RB setting command has been received, the sub CPU 206 sets an RB flag in step S221. After executing the processing of step S221, the sub CPU 206 shifts the processing to step S230. It is to be noted that the RB flag is a flag that is set at the start of RB and cleared at the end of RB.

In step S230, the sub CPU 206 determines whether or not a BB setting command has been received. When determining that the BB setting command has not been received, the sub CPU 206 shifts the processing to step S240. On the other hand, when determining that the BB setting command has been received, the sub CPU 206 sets a BB flag in step S231. After executing the processing of step S231, the sub CPU 206 shifts the processing to step S240. It is to be noted that the BB flag is a flag that is set at the start of BB and cleared at the end of BB.

When determining in step S230 that the BB setting command has not been received, or when executing the processing of step S231, the sub CPU 206 determines whether or not an RB cancel command has been received (step S240). When determining that the RB cancel command has been received, the sub CPU 206 clears the RB flag (step S241).

When determining in step S240 that the RB cancel command has not been received, or when executing the processing of step S241, the sub CPU 206 determines whether or not a BB cancel command has been received (step S250). When determining that the BB cancel command has not been received, the sub CPU 206 completes the present subroutine. On the other hand, when determining that the BB cancel command has been received, the sub CPU 206 clears the BB flag (step S251), and completes the present subroutine.

FIG. 11 is a flowchart showing a subroutine of sound output control processing performed in the voice control circuit.

The sound source IC 232 generates a sound corresponding to various data supplied from the sub CPU 206.

When having not been supplied with the effect pattern data from the sub CPU 206 (step S400: NO), the sound source IC 232 returns the processing to step S400.

When the sound source IC 232 has been supplied with the effect pattern data (specific effect pattern data or normal effect pattern data) from the sub CPU 206 (step S400: YES), and not supplied with the end effect pattern data (end specific effect pattern data or end normal effect pattern data) (step S401: NO), the sound source IC 232 extracts first sound data from the voice data ROM 234 and stores the extracted data in the buffer (step S402). On the other hand, when having been supplied with the effect pattern data from the sub CPU 206 (step S400: YES), and supplied with the end effect pattern data (step S401: NO), the sound source IC 232 extracts the first sound data for the ending time from the voice data ROM 234 and stores the extracted data in the buffer (step S403).

After executing the processing of step S402 or step S403, the sound source IC 232 determines whether or not the effect pattern data is the effect pattern data for BB (normal effect pattern data for BB or specific effect pattern data for BB) (step S404). When determining that the effect pattern data is not the effect pattern data for BB, the sound source IC 232 shifts the processing to step S406. On the other hand, when determining that the effect pattern data is the effect pattern data for BB, the sound source IC 232 converts the extracted sound data into second sound data showing a specific waveform (step S405). In the processing, the sound source IC 232 extracts inaudible sound data from the voice data ROM 234, and then performs processing of synthesizing the extracted sound data with the first sound data extracted in step S402 or step S403.

In step S406, the sound source IC 232 outputs a voice to the speakers 21 at each prescribed timing (e.g. every 1/30 of a second), based upon the first sound data extracted in step S402 or step S403 or the second sound data converted in step S405 (step S406).

Subsequently, when the effect has not ended (step S407: NO), the sound source IC 232 returns the processing to step S400. On the other hand, when the effect has ended (step S407: YES), the sound source IC 232 clears the pattern data (step S408), and returns the processing to step S400.

In the present embodiment, the case has been described where sound data extracted based upon the effect pattern data is one piece of data and is the first sound data. However, in the present invention, sound data extracted based upon the effect pattern data may be a plurality of pieces of data. For example, sound data extracted based upon the effect pattern data may be a plurality pieces of data including game sound data in accordance with a gaming state and constantly outputted sound data indicating a sound that is constantly and repeatedly outputted irrespective of the gaming state, and the constantly outputted sound data may be the first sound data.

FIG. 12 is a flowchart showing a subroutine of display control processing performed in the display control circuit.

The VDP 212 generates screen images corresponding to a variety of data supplied from the sub CPU 206.

When having not been supplied with effect pattern data from the sub CPU 206 (step S300: NO), the VDP 212 extracts a demonstration image from the image data ROM 216 and stores the image in the buffer (step S301).

When the VDP 212 has been supplied with effect pattern data from the sub CPU 206 (step S300: YES) and the effect pattern data is not specific effect pattern data (step S302: NO), the VDP 212 shifts the processing to step S303.

When having not been supplied with end effect pattern data in step S303 (step S303: NO), the sub CPU 206 extracts a normal effect image from the image data ROM 216 and stores the image in the buffer (step S304). On the other hand, when end effect pattern data is supplied (step S303: YES), a normal effect image for the ending time is extracted from the image data ROM 216 and the image is stored in the buffer (step S305).

When having been supplied with effect pattern data from the sub CPU 206 (step S300: YES) and the effect pattern data is specific effect pattern data (step S302: YES), the VDP 212 shifts the processing to step S306.

When having not been supplied with end effect pattern data in step S306 (step S306: NO), the sub CPU 206 extracts a specific effect image from the image data ROM 216 and stores the image in the buffer (step S307). On the other hand, when end effect pattern data is supplied (step S306: YES), a specific effect image for the ending time is extracted from the image data ROM 216 and the image is stored in the buffer (step S308).

After executing the processing of step S301, S304, S305, S307, or S308, the VDP 212 outputs the screen image to the liquid crystal display 5 at each prescribed timing (e.g. every 1/30 of a second) (step S309).

Thereafter, when the effect has not ended (step S310: NO), the VDP 212 returns the processing to step S300. On the other hand, when the effect has ended (step S310: YES), the VDP 212 clears the pattern data (step S311) and returns the processing to step S300.

As described above, according to the pachislo gaming apparatus 1 of the first embodiment, as triggered by generation of BB, the first sound data included in the effect pattern data is converted into the second sound data including specific data that shows a waveform of a specific inaudible sound, and a sound based upon the second sound data is outputted from the speakers 21. On the other hand, in another pachislo gaming apparatus 1, when it is determined that the input sound includes a specific sound based upon specific data, specific effect pattern data is extracted from the program ROM 208, and the effect is executed based upon the extracted effect pattern data. Therefore, with a plurality of such pachislo gaming apparatuses 1 installed in the game parlor, when a sound including the specific sound therein is outputted from the speakers 21 provided in one pachislo gaming apparatus 1, the sound spreads therearound, and hence a specific effect is executed in a pachislo gaming apparatus 1 installed around the pachislo gaming apparatus 1 that has outputted the sound.

As described above, according to the pachislo gaming apparatus 1, it is possible to produce a completely new effect where, when BB is generated in one pachislo gaming apparatus 1, a pachislo gaming apparatus 1 around the pachislo gaming apparatus 1 executes an effect as if it resonates. The effect involving another player in the game parlor can enhance vibrancy in the entire game parlor, and expectation of a player who has not yet hit a jackpot.

Further, since the prescribed effect is executed in another pachislo gaming apparatus 1, the player playing a game on the pachislo gaming apparatus 1 that has generated BB can feel a sense of superiority. Moreover, when a sound including the specific sound therein is outputted, another pachislo gaming apparatus 1 having the microphone 44 collects the sound, and it is thus unnecessary to perform a wiring operation such as connection between the pachislo gaming apparatuses 1 or between the pachislo gaming apparatuses 1 and a management device. As thus described, since it is configured so as to execute an effect through sounds, the cost and time taken for investment in facilities can be reduced.

Further, according to the pachislo gaming apparatus 1, it is directly determined whether or not the specific sound is included, thereby allowing prevention of malfunction.

Moreover, according to the pachislo gaming apparatus 1, since the second sound data is data including specific data showing a waveform of a specific inaudible sound, it is possible to execute the effect without making the player aware of a change in sound outputted from the pachislo gaming apparatus 1.

Further, according to the pachislo gaming apparatus 1, since the second sound data is data including specific data that shows a specific waveform corresponding to identification data for identifying the pachislo gaming apparatus 1 installed in the game parlor, when a sound based upon the second sound data outputted from the speakers 21 is inputted into another pachislo gaming apparatus 1 having the microphone 44, it is possible in the another pachislo gaming apparatus 1 to recognize from which pachislo gaming apparatus 1 the sound has been outputted.

Moreover, according to the pachislo gaming apparatus 1, since the interface 92 for data input for inputting identification data is provided, it is possible to easily input or change the identification data.

In the present embodiment, the case has been described where, while the first sound data and the inaudible sound data are synthesized and converted into the second sound data, it is determined whether or not part of the waveform shown by the output waveform data (prescribed inaudible frequency band portion) includes a waveform identical or similar to a specific waveform shown by the comparison waveform data. However, in the present invention, while the first sound data is converted into the second sound data showing a waveform obtained by amplifying by a prescribed amount an amplitude in a specific frequency band of the waveform shown by the specific data, it may be determined whether or not part of the waveform shown by the output waveform data (prescribed audible frequency band portion) includes a waveform identical or similar to a specific waveform shown by the comparison waveform data.

In this case, for example, while equalizer processing where an amplitude in a specific frequency band is amplified by a prescribed amount (processing of adjusting a level of a sound signal in each of a plurality of frequency bands different from one another) is performed as processing of conversion into the second sound data including specific data, determination of whether or not part of the waveform shown by the output waveform data (prescribed audible frequency band portion) includes a waveform identical or similar to the specific waveform shown by the comparison waveform data can be made by performing filter processing (e.g. band-pass filter processing that allows only a signal in a specific frequency band to pass), to extract only a waveform in accordance with the specific data.

FIG. 13 is a diagram for describing second sound data according to another example.

The waveform indicating the first sound data shown in FIG. 7 (a) is subjected to equalizer processing, so that the first sound data can be converted into second sound data that shows a waveform with an amplitude amplified fourfold, the amplitude being in a frequency band in the vicinity of an audible frequency f2.

Therefore, in the case of employing such a configuration, a sound can be processed in a relatively simple technique, and whether or not the sound is the specific sound can also be determined in a relatively simple technique.

In the present embodiment, the case has been described where, while the first sound data and the inaudible sound data are synthesized and converted into the second sound data, part of a waveform of a sound signal based upon an input sound from the microphone includes a waveform identical or similar to a specific waveform. However, in the present embodiment, while the first sound data is synthesized with voice data indicating a specific voice to convert the data into the second sound data, a specific effect may be executed when a sound signal based upon an input sound from the microphone includes the specific voice.

In this case, for example, voice data should be previously stored in a fourth memory (e.g. voice data ROM) while a voice data extraction program should be stored, for example, in the program ROM, and the controller (e.g. control portion) should read and execute the voice data extraction program, so as to execute the following processing (a) to (e) of:

(a) extracting effect pattern data from the first memory;

(b) performing control to execute an effect based upon the extracted effect pattern data;

(c) extracting voice data from the fourth memory;

(d) converting first sound data included in the effect pattern data extracted in the processing (a) into second sound data including the voice data extracted in the processing (c), as triggered by satisfaction of a prescribed condition; and

(e) outputting from the speaker a sound based upon the processed second sound data.

Meanwhile, a voice recognition program should be previously stored, for example, in the program ROM, and the controller (e.g. control portion) should read and execute the voice recognition program, so as to execute the following processing (a) of:

(a) controlling execution of an effect based upon normal effect pattern data when a voice recognition device does not recognize a specific voice, and controlling execution of an effect based upon the specific effect pattern data when the voice recognition device recognizes the specific voice.

It is thereby possible to recognize that a sound signal based upon an input sound from the microphone includes the specific voice. In the case of employing such a configuration, it is possible to execute an effect through the use of a voice having a complicated waveform.

In the present embodiment, the case has been described where the external device is the pachislo gaming apparatus 1. However, the present invention is not limited thereto, and for example, it may be configured such that a sound outputted from the speaker of the gaming machine is collected by equipment having a microphone therein in the game parlor. In such a case, it is possible in the equipment to execute an effect of playing prescribed music or a voice in the parlor, an effect of applying a spotlight in a direction toward the gaming machine that has emitted the sound, and the like.

In the present embodiment, the case has been described where a sound including a specific sound therein is outputted as triggered by generation of BB. However, in the present invention, the prescribed condition is not limited to this case. The prescribed condition may be that: the number of payouts of game media or a difference in number of game media has reached a prescribed number; prescribed time has come; a prescribed period has elapsed from start of a game or from execution of the last game; or the like.

Next, the case of applying the present invention to a slot machine is described as a second embodiment.

### Second Embodiment

FIG. 14 is a perspective view schematically showing a slot machine according to the second embodiment of the present invention.

The slot machine 1010 includes a cabinet 1011, a top box 1012 installed on the upper side of the cabinet 1011, and a main door 1013 provided at the front face of the cabinet 1011. The slot machine 1010 corresponds to the gaming machine of the present invention.

A lower image display panel 1016 is provided at the front of the main door. The lower image display panel 1016 is provided with a liquid crystal panel and displays fifteen display blocks 1028 made up of five columns and three rows. One symbol is to be arranged in each of the display blocks 1028.

Further, on the lower image display panel 1016, one winning line L is formed horizontally across the five display blocks 1028 displayed in the middle of the respective columns. The winning line L defines a combination of symbols.

Moreover, a number-of-credits display portion 1031 and a number-of-payouts display portion 1032 are set in the lower image display panel 1016. In the number-of-credits display portion 1031, the number of credited coins is displayed by an image. In the number-of-payouts display portion 1032, the number of coins to be paid out in the case of the symbol combination arranged along the winning line L being a prescribed combination is displayed by an image. Further, a microphone 1544 is provided on the right and left of the front of the lower image display panel 1016.

Under the lower image display panel 1016 are provided a control panel 1020 including a plurality of buttons 1023 to 1027 with which commands relating to game progressions are inputted by the player, a coin receiving slot 1021 through which coins are accepted into the cabinet 1011, and a bill validator 1022.

The control panel 1020 is provided with a spin button 1023, a change button 1024, a cash-out button 1025, a 1-BET button 1026, and a maximum BET button 1027. The spin button 1023 is used for inputting a command to start scroll of symbols. The change button 1024 is used in making a request of an attendant of a gaming facility for money exchange. The cash-out button 1025 is used for inputting a command to pay out credited coins to a coin tray 1018.

The 1-BET button 1026 is used for inputting a command to bet one coin in a game, out of credited coins. The maximum BET button 1027 is used for inputting a command to bet the maximum number of coins that can be bet in one game (50 coins in the present embodiment).

The bill validator 1022 verifies whether or not a bill is proper and accepts a regular bill into the cabinet 1011. It is to be noted that the bill validator 1022 may be configured so as to read a later-described ticket 1039 with a barcode. Belly glass 1034 having a character of the slot machine 1010 or the like drawn thereon is provided on the lower front of the main door 1013, namely, under the control panel 1020.

An upper image display panel 1033 is provided at the front face of the top box 1012. The upper image display panel 1033 is provided with a liquid crystal panel, and for example, displays an image representing introduction of game contents and explanation of a game rule.

Further, the top box 1012 is provided with a speaker 1029. Under the upper image display panel 1033 are provided a ticket printer 1035, a card reader 1036, a data display 1037, and a key pad 1038. The ticket printer 1035 prints a barcode on a ticket as coded data of the number of credits, a date, an identification number of the slot machine 1010, and the like, and outputs the ticket as the ticket 1039 with a barcode. The player can make another slot machine read the ticket 1039 with a barcode to play a game thereon, or can exchange the ticket 1039 with a barcode with a bill or the like at a prescribed place in the gaming facility (e.g. a cashier in a casino).

The card reader 1036 reads data from a smart card and writes data into the smart card. The smart card is a card owned by the player, and for example stores data for identifying the player and data regarding a history of games played by the player. The smart card may store data corresponding to coins, bills or credits. Further, a magnetic stripe card may be adopted in place of the smart card. The data display 1037 is comprised of a fluorescent display and the like, and for example, displays data read by the card reader 1036 and data inputted by the player through the key pad 1038. The key pad 1038 is for inputting a command and data regarding ticket issuance and the like.

FIG. 15 is a diagram showing symbols and code numbers of the respective symbols.

As shown in FIG. 15, to the respective display blocks 1028, arrays of a total of 22 symbols consisting of code numbers “00” to “21” are scrolled. Each of the symbol arrays is made up of a combination of “JACKPOT 7”, “BLUE 7”, “BELL”, “CHERRY”, “STRAWBERRY”, “PLUM”, “ORANGE”, and “APPLE”.

When five symbols of “JACKPOT 7”, “BLUE 7”, “BELL”, “CHERRY”, “STRAWBERRY”, “PLUM”, “ORANGE”, or “APPLE” are rearranged along the winning line L, coins in a previously set number is paid out (cf. FIG. 21).

When the spin button 1023 is pressed down after pressing-down of the 1-BET button 1026 or the maximum BET button 1027, to start a game, symbols are scrolled downwardly. After the lapse of a prescribed time, symbols are rearranged. When a prize is won at this time, payout of coins in previously set number can be received (cf. FIG. 21).

FIG. 16 is a block diagram showing an internal configuration of the slot machine shown in FIG. 14.

A gaming board 1050 is provided with: a CPU (Central Processing Unit) 1051, a ROM 1055, and a boot ROM 1052, which are mutually connected through an internal bus; a card slot 1053S corresponding to a memory card 1053; and an IC socket 1054S corresponding to a GAL (Generic Array Logic) 1054.

The memory card 1053 is comprised of a nonvolatile memory such as CompactFlash (registered trademark) and stores a game program. The game program includes a symbol determination program. The symbol determination program is a program for determining symbols (code No. corresponding to symbols) to be arranged along the winning line L.

Further, the card slot 1053S is configured so that the memory card 1053 can be inserted thereinto and removed therefrom, and is connected to a mother board 1040 through an IDE bus. Therefore, it is possible to change the type and contents of a game played on the slot machine 1010 by removing the memory card 1053 from the card slot 1053S, writing another game program into the memory card 1053, and inserting the memory card 1053 into the card slot 1053S. The game program includes a program relating to game progressions. Further, the game program includes image data and sound data to be outputted during the game.

The CPU 1051, the ROM 1055 and the boot ROM 1052, which are mutually connected through the internal bus, are connected to the mother board 1040 through a PCI bus. The PCI bus transmits a signal between the mother board 1040 and the gaming board 1050 and supplies power from the mother board 1040 to the gaming board 1050.

The mother board 1040 is configured using a commercially available general-purpose mother board (print wiring board mounted with fundamental components of a personal computer), and includes a main CPU 1041, a ROM (Read Only Memory) 1042, a RAM (Random Access Memory) 1043, and a communication interface 1044 (not shown). The mother board 1040 corresponds to the controller in the present invention.

The ROM 1042 is comprised of a memory device such as a flash memory, and stores a program such as a BIOS (Basic Input/Output System) executed by the main CPU 1041 and permanent data. When the BIOS is executed by the main CPU 1041, processing of initializing prescribed peripheral devices is performed concurrently with start of processing of downloading the game program stored in the memory card 1053 through the gaming board 1050. It should be noted that in the present invention, the ROM 1042 may or may not be a ROM with its contents rewritable.

The RAM 1043 stores data and a program to be used in operation of the main CPU 1041. Further, the RAM 1043 is capable of storing a game program.

Further, the RAM 1043 stores the number of credits, data on the number of inserted coins and the number of payouts in one game, and the like.

Moreover, the mother board 1040 is connected with a later-described body PCB (Printed Circuit Board) 1060 and a door PCB 1080, through respective USBs. Further, the mother board 1040 is connected with a power supply unit 1045.

The body PCB 1060 and the door PCB 1080 are connected with an instrument and a device that generate an input signal to be inputted into the main CPU 1041, and an instrument and a device operations of which are controlled by a control signal outputted from the main CPU 1041. The main CPU 1041 executes the game program stored in the RAM 1043 based upon an input signal inputted into the main CPU 1041, to perform prescribed arithmetic processing and store its result into the RAM 1043 or to transmit a control signal to each instrument and device as processing of controlling each instrument and device.

The body PCB 1060 is connected with a lamp 1030, a hopper 1066, a coin detecting portion 1067, a graphic board 1068, the speaker 1029, a touch panel 1069, the bill validator 1022, the ticket printer 1035, the card reader 1036, a key switch 1038S, and the data display 1037. The lamp 1030 is lighted in a prescribed pattern based upon a control signal outputted from the main CPU 1041.

Further, the body PCB 1060 is connected, through a signal processing circuit 1544a, with the microphone 1544 that converts an input sound from the outside into a sound signal and outputs the signal. The signal processing circuit 1544a is a circuit which includes a variety of circuits such as an AGC circuit and an A/D conversion circuit and performs a variety of processing for converting a sound signal outputted from the microphone 1544 into output waveform data. The AGC circuit automatically controls an amplification factor of an amplifier provided inside thereof so as to obtain a fixed output even when a magnitude of an input sound signal fluctuates.

Moreover, the body PCB 1060 is connected with an interface 1092 for data input for inputting identification data of the slot machine 1010. Identification data inputted from the interface 1092 for data input is stored in the RAM 1043. The RAM 1043 corresponds to the second memory in the present invention.

The hopper 1066 is installed inside the cabinet 1011 and pays out a prescribed number of coins from a coin payout exit 1019 to the coin tray 1018, based upon the control signal outputted from the main CPU 1041. The coin detecting portion 1067 is provided inside the coin payout exit 1019 and outputs an input signal to the main CPU 1041 in the case of detecting payout of the prescribed number of coins from the coin payout exit 1019.

The graphic board 1068 controls image display on the upper image display panel 1033 and the lower image display panel 1016, based upon the control signal outputted from the main CPU 1041. An image corresponding to effect pattern data is displayed to the lower image display panel 1016. Scrolled or rearranged symbols are displayed to the respective display blocks 1028 of the lower image display panel 1016. The number of credits stored in the RAM 1043 is displayed in the number-of-credits display portion 1031 of the lower image display panel 1016. Further, the number of payouts of coins is displayed in the number-of-payouts display portion 31 of the lower image display panel 1016.

The graphic board 1068 has a VDP (Video Display Processor) that generates image data based upon the control signal outputted from the main CPU 1041, a video RAM that temporarily stores image data generated by the VDP, and the like.

Image data used in generation of image data by the VDP is included in the game program read from the memory card 1053 and stored in the RAM 1043.

The RAM 1043 stores a plurality of kinds of effect pattern data corresponding to screen images displayed to the upper image display panel 1033 and sounds outputted from the speaker 1029. The effect pattern data is classified into normal effect pattern data and specific effect pattern data. Examples of the effect pattern data (normal effect pattern data and specific effect pattern data) include background image data that constitutes a background image, and character image data that shows a character.

The specific effect pattern data is effect pattern data regarding an image that is displayed only when a specific sound is inputted from the microphone 1544 (e.g. a fireworks image 1093a and a notification image 1093b shown in FIG. 19). The normal effect pattern data is effect pattern data regarding an image that is displayed when the specific sound has not been inputted from the microphone 1544.

The RAM 1043 corresponds to the first memory in the present invention. Further, the RAM 1043 corresponds to the third memory in the present invention.

Further, the RAM 1043 stores a plurality of kinds of sound data. The sound data includes, for example, sound data regarding an effect (hereinafter referred to as “first sound data”) and inaudible sound data showing an inaudible sound that is outputted as triggered by generation of a bonus game. A plurality of pieces of inaudible sound data are stored in association with identification data inputted from the interface 1092 for data input. The inaudible specific data corresponds to the specific data in the present invention.

Moreover, the RAM 1043 stores comparison waveform data as an object to be compared with a waveform shown by a sound signal outputted from the microphone 1544.

The bill validator 1022 verifies whether or not a bill is proper and accepts a regular bill into the cabinet 1011. Upon acceptance of the regular bill, the bill validator 1022 outputs an input signal to the main CPU 1041, based upon an amount of the bill. The main CPU 1041 stores the number of credits in accordance with the bill amount transmitted by the input signal into the RAM 1043.

The ticket printer 1035 prints on a ticket a barcode formed by encoding data such as the number of credits stored in the RAM 1043, a date, and an identification number of the slot machine 1010, based upon the control signal outputted from the main CPU 1041, and outputs the ticket as the ticket 1039 with a barcode.

The card reader 1036 reads data from a smart card and transmits the read data to the main CPU 1041, or writes data into the smart card based upon the control signal from the main CPU 1041. The key switch 1038S is provided on the key pad 1038 and outputs a prescribed input signal to the main CPU 1041 when the key pad 1038 is operated by the player. The data display 1037 displays data read by the card reader 1036 and data inputted by the player through the key pad 1038, based upon the control signal outputted from the main CPU 1041.

The door PCB 1080 is connected with a control panel 1020, a reverter 1021S, a coin counter 1021C, and a cold cathode tube 1081. The control panel 1020 is provided with a spin switch 1023S corresponding to the spin button 1023, a change switch 1024S corresponding to the change button 1024, a CASHOUT switch 1025S corresponding to the CASHOUT button 1025, a 1-BET switch 1026S corresponding to the 1-BET button 1026, and a maximum BET switch 1027S corresponding to the maximum BET button 1027. The switches 1023S to 1027S output input signals to the main CPU 1041 when the respective corresponding buttons 1023 to 1027 are operated by the player.

The coin counter 1021C is provided inside the coin receiving slot 1021, and identifies whether or not coins inserted into the coin receiving slot 1021 by the player are proper. A coin other than a regular coin is discharged from the coin payout exit 1019. Further, the coin counter 1021C outputs an input signal to the main CPU 1041 when detecting the regular coin.

The reverter 1021S operates based upon the control signal outputted from the main CPU 1041 and distributes a coin recognized as the regular coin by the coin counter 1021C into a cash box (not shown) installed inside the slot machine 1010 or into the hopper 1066. That is, when the hopper 1066 is filled with coins, the regular coin is distributed into the cash box by the reverter 1021S. On the other hand, when the hopper 1066 is not filled with coins, the regular coin is distributed into the hopper 1066. The cold cathode tube 1081 functions as a backlight installed on the rear surface side of the lower image display panel 1016 and the upper image display panel 1033, and is lighted based upon the control signal outputted from the main CPU 1041.

Next, processing performed in the slot machine 1010 is described.

The main CPU 1041 reads and executes a game program so as to proceed with a game.

FIG. 17 is a flowchart showing a subroutine of sound recognition processing.

First, in step S500, the main CPU 1041 receives output waveform data, generated based upon an input sound inputted from the microphone 1544, from the signal processing circuit 1544a.

Next, the main CPU 1041 references comparison waveform data stored in the RAM 1043 (step S501) and determines whether or not part of a waveform shown by the output waveform data includes a waveform identical or similar to a specific waveform shown by the comparison waveform data (step S502). In the processing, the main CPU 1041 determines whether or not the waveforms are identical or similar to each other, based upon a similarity obtained by a prescribed calculation formula.

When it is determined that part of the waveform shown by the output waveform data (the prescribed inaudible frequency band portion in the present embodiment) does not include a waveform identical or similar to the specific waveform shown by the comparison waveform data (step S502: NO), the present subroutine is completed. On the other hand, when it is determined that part of the waveform shown by the output waveform data includes a waveform identical or similar to the specific waveform shown by the comparison waveform data (step S502: YES), the main CPU 1041 sets a specific sound detection flag in step S503. After execution of the processing of step S503, the present subroutine is completed. It is to be noted that the specific sound detection flag is a flag that indicates detection of a specific sound, and a flag that is cleared after the lapse of a prescribed period after the setting.

FIG. 18 is a flowchart showing a subroutine of game execution processing.

In the game execution processing, first, the main CPU 1041 determines whether or not coins have been betted (step S1010). In the processing, the main CPU 1041 determines whether or not to have received an input signal which is outputted from the 1-BET switch 1026S when the 1-BET button 1026 is operated or an input signal which is outputted from the maximum BET switch 1027S when the maximum BET button 1027 is operated. When determining that coins have not been betted, the main CPU 1041 returns the processing to step S1010.

On the other hand, when determining in step S1010 that coins have been betted, the main CPU 1041 performs processing of subtraction from the number of credits stored in the RAM 1043 in accordance with the number of betted coins (step S1011). It is to be noted that, when the number of betted coins is larger than the number of credits stored in the RAM 1043, the main CPU 1041 returns the processing to step S10 without performing the processing of subtraction from the number of credits stored in the RAM 1043. Moreover, when the number of betted coins exceeds an upper limit value of a bet in one game (50 in the present embodiment), the main CPU 1041 advances the processing to step S1012 without performing the processing of subtraction from the number of credits stored in the RAM 1043.

Next, in step S1012, the main CPU 1041 determines whether or not the spin button 1023 has been turned on. In the processing, the main CPU 1041 determines whether or not to have received an input signal which is outputted from the spin switch 1023S when the spin button 1023 is pressed down.

When determining that the spin button 1023 has not been turned on, the main CPU 1041 returns the processing to step S1010. It is to be noted that, when the spin button 1023 is not turned on (e.g. when a command indicating to end the game is inputted without turning-on of the spin button 1023), the main CPU 1041 cancels the subtraction result in step S1011.

When determining in step S1012 that the spin button 1023 has been turned on, the main CPU 1041 determines whether or not the specific sound detection flag has been set in step S1013. When determining that the specific sound detection flag has been set, the main CPU 1041 selects a specific effect pattern (step S1014). On the other hand, when determining that the specific sound detection flag has not been set, the main CPU 1041 selects a normal effect pattern (step S1015).

When the specific effect pattern is selected, an image shown in FIG. 19 is displayed to the lower image display panel 1016.

FIG. 19 is a view showing an example of images displayed to the lower image display panel 1016.

To the lower image display panel 1016, a specific effect image 1093, which includes fireworks images 1093a and a notification image 1093b notifying generation of a bonus game on another slot machine 1010, is displayed. This image is an image displayed when it is determined that input of the specific sound is made from the microphone 1544. In a game parlor installed with a plurality of slot machines 1010, when the specific sound is outputted from a single slot machine 1010, a specific effect image is displayed simultaneously to the other slot machines 1010 installed within a prescribed range from the single slot machine 1010.

After the processing of step S1014 or step S1015, the main CPU 1041 performs symbol determination processing (step S1016). In this symbol determination processing, the main CPU 1041 executes a symbol determination program stored in the RAM 1043, to determine code Nos. at the stop of symbols. The processing is detailed later with reference to FIG. 20, FIG. 21.

Next, in step S1017, the main CPU 1041 performs scroll-display control processing. The processing is processing of controlling display of symbols so as to rearrange the symbols determined in step S1016 after the start of symbol scroll.

Next, the main CPU 1041 determines whether or not a bonus game trigger has been established, namely, “APPLE” has been stop-displayed in the display block 1028 in the middle of each column (step S1018). When determining that the bonus trigger has been established, the main CPU 1041 reads a program for playing a bonus game from the RAM 1043 and executes bonus game processing (step S1019). As for the bonus game processing, FIG. 22 is described in detail later.

On the other hand, when determining that the bonus game trigger has not been established, the main CPU 1041 determines whether or not a prize has been established (step S1020). When determining that the prize has been established, the main CPU 1041 pays out coins in number corresponding to the number of inserted coins and the prize (step S1021) and completes the present subroutine. On the other hand, when determining that the prize has not been established, the present subroutine is completed.

FIG. 20 is a flowchart showing a subroutine of symbol determination processing. The processing is processing performed by execution of the symbol determination program stored in the RAM 1043, by the main CPU 1041.

First, the main CPU 1041 executes a random number generation program included in the symbol determination program, to select a random number value corresponding to each of the symbol arrays, out of the numeric values within the range of 0 to 255 (step S1031). In the present embodiment, the case of generating random numbers in the program (the case of using so-called software random numbers) is described. However, in the present invention, a random number generator may be previously provided, and random numbers may be extracted from the random number generator (so-called hardware random numbers may be used).

Next, based upon the selected five random number values, the main CPU 1041 determines a code No. of each symbol array (cf. FIG. 15) (step S1032). The code No. of each symbol array corresponds to the code No. of a symbol to be stop-displayed along the winning line L. The main CPU 1041 determines a prize by determining the code No. of each symbol array. For example, when the main CPU 1041 determines the code Nos. of the symbols to be “00”, “00”, “00”, “00”, and “00”, it means that the main CPU 1041 determines the prize to be “JACKPOT 7”.

Here, prizes in the present embodiment are described.

FIG. 21 is a diagram showing the relation between prizes and the numbers of payouts.

When five symbols of “APPLE” are arranged along the winning line L, the bonus game is generated. In the bonus game, free games in number set by selection of a random number are executed.

Further, when five symbols of “JACKPOT 7” are arranged along the winning line L, thirty coins are paid out per inserted coin. Similarly, when five symbols of “BLUE 7”, “BELL”, “STRAWBERRY”, “PLUM”, “CHERRY”, or “ORANGE” are arranged along the winning line L, coins are paid out in number corresponding to each of the prizes.

FIG. 22 is a flowchart showing a subroutine of the bonus game processing.

First, the main CPU 1041 determines the number of games out of 10 to 25 by acquiring a random number value (step S1060). The main CPU 1041 stores as data the determined number of games of the bonus game, in the RAM 1043.

Next, in step S1061, the main CPU 1041 determines whether or not the specific sound detection flag has been set. When determining that the specific sound detection flag has been set, the main CPU 1041 selects a specific effect pattern for a bonus game (step S1062). On the other hand, when determining that the specific sound detection flag has not been set, the main CPU 1041 selects a normal effect pattern for a bonus game (step S1063).

Next, in step S1064, the main CPU 1041 extracts first sound data from the RAM 1043 and stores the data in the buffer.

Next, in step S1065, the main CPU 1041 converts the extracted first sound data into second sound data showing a specific waveform. In the processing, the main CPU 1041 extracts inaudible sound data from the RAM 1043 and performs processing of synthesizing the data with the first sound data extracted in step S1064. Subsequently, based upon the second sound data, the main CPU 1041 outputs a voice to the speaker 1029 at each prescribed timing (e.g. every 1/30 of a second).

It is to be noted that, since the processing of converting the first sound data into the second sound data showing a specific waveform has already been described with reference to FIG. 7, description thereof is omitted here.

Next, the main CPU 1041 performs symbol determination processing (step S1066). The processing of step S1066 is substantially the same as the processing described with reference to FIG. 18. Since the processing has already been described, description thereof is omitted here.

Next, the main CPU 1041 performs scroll-display control processing (step S1067). The processing of step S1067 is substantially the same as the processing described with reference to FIG. 18. Since the processing has already been described, description thereof is omitted here.

Next, the main CPU 1041 determines whether or not a bonus game trigger has been established, namely, whether or not “APPLE” has been stop-displayed (step S1068). When determining that the bonus game trigger has been established, the main CPU 1041 newly determines a repeating number t of bonus games is newly determined (step S1069), and the determined repeating number t is added to the number T of games of the current bonus games (step S1070). In this manner, when a bonus game is won during the bonus game, the remaining number of bonus games increases. Specifically speaking, for example, in the case where the game is shifted to 20 bonus games for the first time and 17 bonus games are won in the 12th bonus game, 25 (=20−12+17) bonus games will be played thereafter.

When a bonus game trigger is not established, the main CPU 1041 determines whether or not a prize has been established (step S1071). When determining that a prize has been established, the main CPU 1041 pays out coins corresponding to the number of inserted coins and the prize (step S1072).

When executing the processing of step S1070 or step S1071, or when determining in step S1072 that any prize has not been established (determining that the game is lost), the main CPU 61 reads the number T of games of the bonus games stored in the RAM 1043, and subtracts one from the read value of the number T of games. Then, the main CPU 1041 stores in the RAM 1043 the number T of games after the subtraction again (step S1073).

Next, the main CPU 1041 determines whether or not the number T of bonus games has reached the number determined in step S1060 (step S1074). Specifically, the main CPU 1041 determines whether or not the number T of games stored in the RAM 1043 has become zero, and when determining that the number T of games is not zero, namely, the number of bonus games executed has not reached the number determined in step S1060, the main CPU 1041 returns the processing to step S1061 and repeats the foregoing processing. On the other hand, when determining that the number T of games is zero, namely, the number of bonus games executed has reached the number determined in step S1060, the main CPU 1041 completes the present subroutine.

As described above, according to the slot machine 1010 relating to the second embodiment, as triggered by generation of a bonus game, the first sound data included in the effect pattern data is converted into the second sound data including specific data that shows a waveform of a specific inaudible sound, and a sound based upon the second sound data is outputted from the speaker 1029. Meanwhile, in another slot machine 1010, when it is determined that an input sound includes a specific sound based upon specific data, specific effect pattern data is extracted from the RAM 43, and an effect is executed based upon the extracted effect pattern data. Therefore, with a plurality of such slot machines 1010 installed in a game parlor, when a sound including the specific sound therein is outputted from the speaker 1029 provided in one slot machine 1010, the sound spreads therearound, and thus a slot machine 1010 installed around the slot machine 1010 that has outputted the sound executes a specific effect.

As thus described, according to the slot machine 1010, it is possible to produce a completely new effect where, when the bonus game is generated in one slot machine 1010, a slot machine 1010 around that slot machine 1010 executes an effect as if it resonates. The effect involving another player in the game parlor enhances vibrancy in the entire game parlor and expectation of a player who has not yet hit a jackpot.

Further, since the prescribed effect is executed in another slot machine 1010, a player playing a game on the slot machine 1010 that has generated a bonus game can feel a sense of superiority. Moreover, when a sound including the specific sound therein is outputted, another slot machine 1010 having the microphone 1544 collects the sound, and it is thus unnecessary to perform a wiring operation such as connection between the slot machines 1010 or between the slot machines 1010 and a management device. As thus described, since it is configured so as to execute an effect through sounds, the cost and time taken for investment in facilities can be reduced.

Further, according to the slot machine 1010, it is directly determined from the waveform whether or not the specific sound is included, thereby allowing prevention of malfunction.

Further, according to the slot machine 1010, since the second sound data is data including specific data that shows a waveform of a specific inaudible sound, it is possible to execute an effect without making the player aware of a change in sound outputted from the slot machine 1010.

Further, according to the slot machine 1010, since the second data is data including specific data that shows a specific waveform corresponding to identification data for identifying the slot machine 1010 installed in the game parlor, when a sound based upon the second sound data outputted from the speaker 1029 is inputted into another slot machine 1010 having the microphone 1544, it is possible in the another slot machine 1010 to recognize from which slot machine 1010 the sound has been outputted.

Further, according to the slot machine 1010, since the interface 1092 for data input for inputting the identification data, it is possible to easily input and change the identification data.

In the foregoing embodiments, the cases of applying the present invention to a pachislo gaming apparatus and a slot machine have been described. However, the present invention is also applicable to another gaming machine (e.g. pachinko gaming apparatus, and the like).

Although the embodiments according to the present invention have been described above, the descriptions present only some of specific examples and do not particularly limit the present invention, and a specific configuration of each means or the like can be appropriately changed in terms of design. Further, the effects described in the embodiments of the present invention are only examples of the most preferable effects obtained from the present invention, and the effect to be exerted by the present invention is not limited to those described in the embodiments of the present invention.

Moreover, in the foregoing detailed descriptions, characteristic portions have been primarily described for the purpose of making the present invention more readily understood. The present invention is not limited to the embodiments in the foregoing detailed descriptions but is applicable to other embodiments, and the range of application is diverse. Further, terms and wording in the specification are used for accurately describing the present invention and not for limiting interpretation of the present invention. It may be apparent for a person skilled in the art to conceive, from the concept of the invention described in the specification, another configuration, system, method, and the like included in the concept of the present invention. It is therefore necessary to consider that recitation of the claims includes equivalent configuration in the range not departing from the range of technical ideas of the present invention. Moreover, an object of the abstract is to make the technical contents and nature of the present application readily determinable through simple search by a patent office, a general public institution, an engineer in the technical field who is not familiar with patents, legal terms, or technical terms, and the like. Therefore, the abstract is not intended to limit the scope of the invention to be evaluated with the recitation of the claims. Furthermore, it is desirable to sufficiently consider an already disclosed document and the like in order to fully understand an object of the present invention as well as an effect specific to the present invention.

The foregoing detailed descriptions include processing executed by a computer. The foregoing descriptions and expressions are made for the purpose of being understood by a person skilled in the art in the most efficient manner. In the specification, each step to be used for deriving one result should be understood as self-consistent processing. Further, transmission/reception, recording, and the like of an electrical or magnetic signal are performed in each step. Although such a signal is expressed by means of a bit, a value, a symbol, a letter, a term, a number, or the like in the processing of each step, it is necessary to note that these are used simply for the sake of convenience in description. Moreover, although the processing in each step may be described using an expression in common with a human action, the processing described in the present specification is essentially executed by a variety of devices. Furthermore, other configurations required for performing each of the steps become apparent from the foregoing descriptions.

### BRIEF DESCRIPTION OF THE DRAWINGS

FIG. 1 is a perspective view schematically showing an example of a pachislo gaming apparatus according to a first embodiment of the present invention.

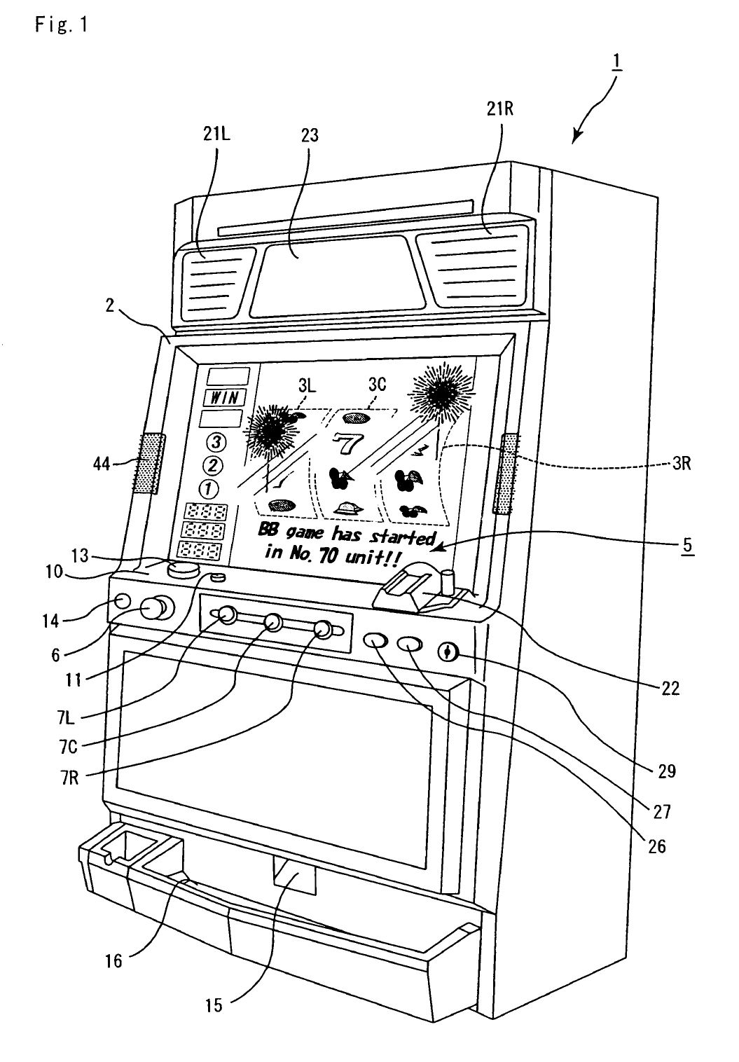

FIG. 2 is an enlarged front view showing the neighborhood of a liquid crystal display provided in the pachislo gaming apparatus shown in FIG. 1.

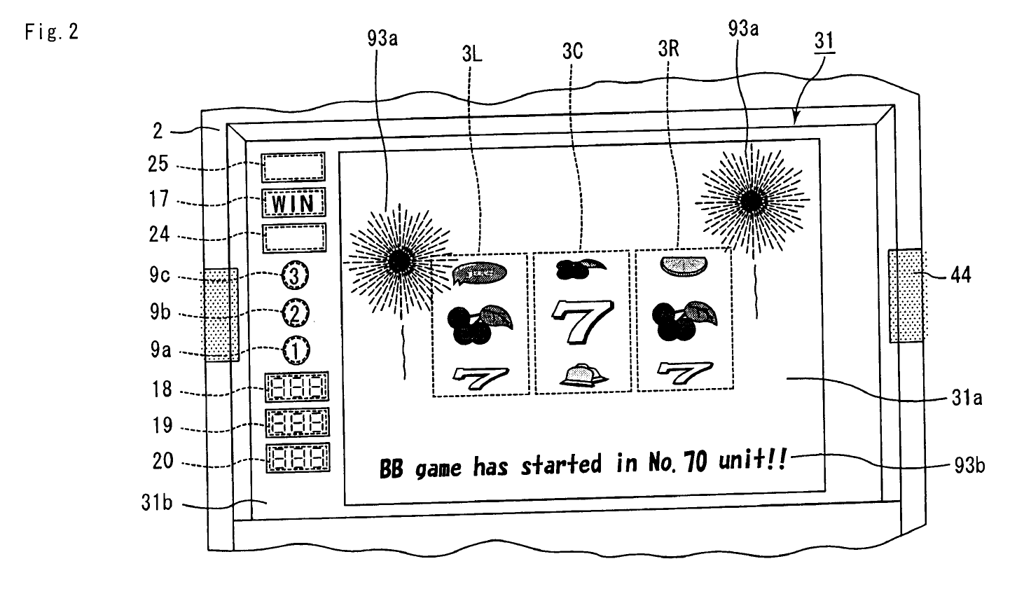

FIG. 3 is a perspective view showing a schematic configuration of the liquid crystal display provided in the pachislo gaming apparatus shown in FIG. 1.

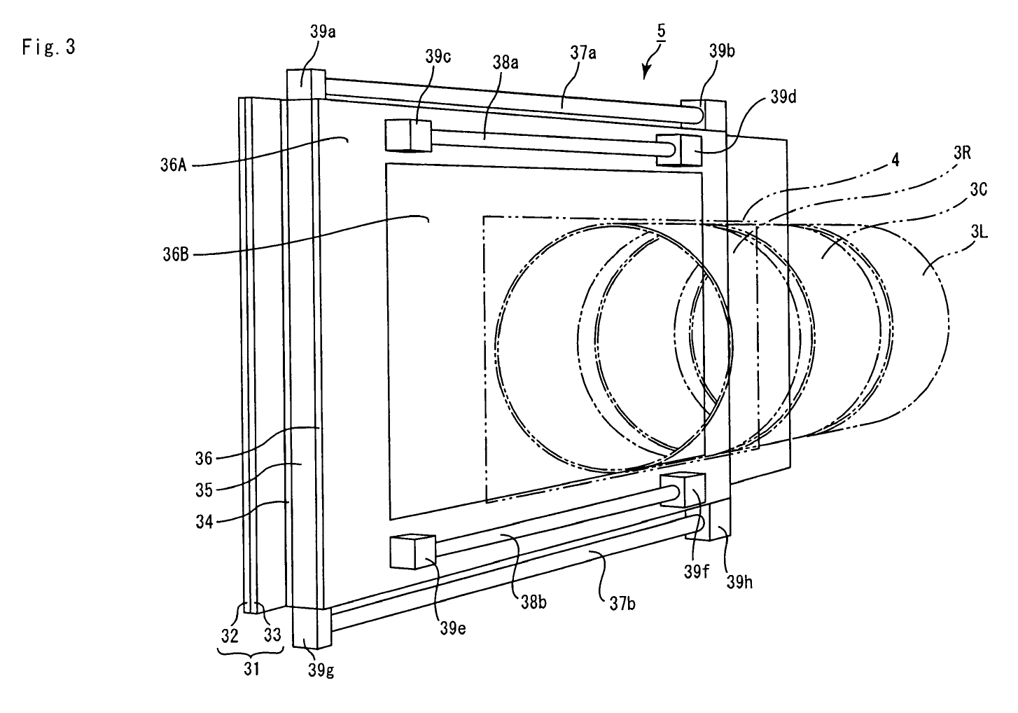

FIG. 4 is an exploded view of a configuration of part of the liquid crystal display shown in FIG. 3.

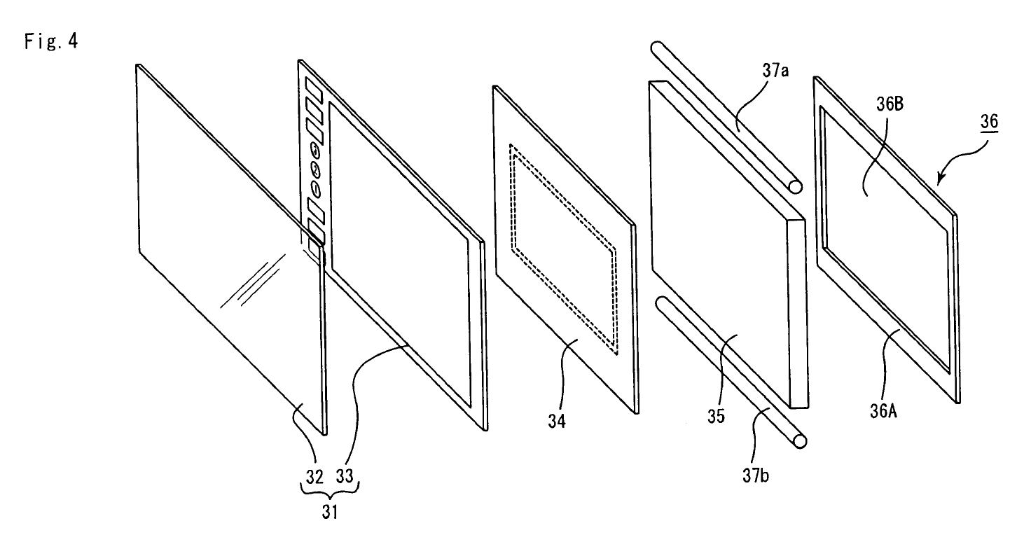

FIG. 5 is a block diagram showing an internal configuration of the pachislo gaming apparatus shown in FIG. 1.

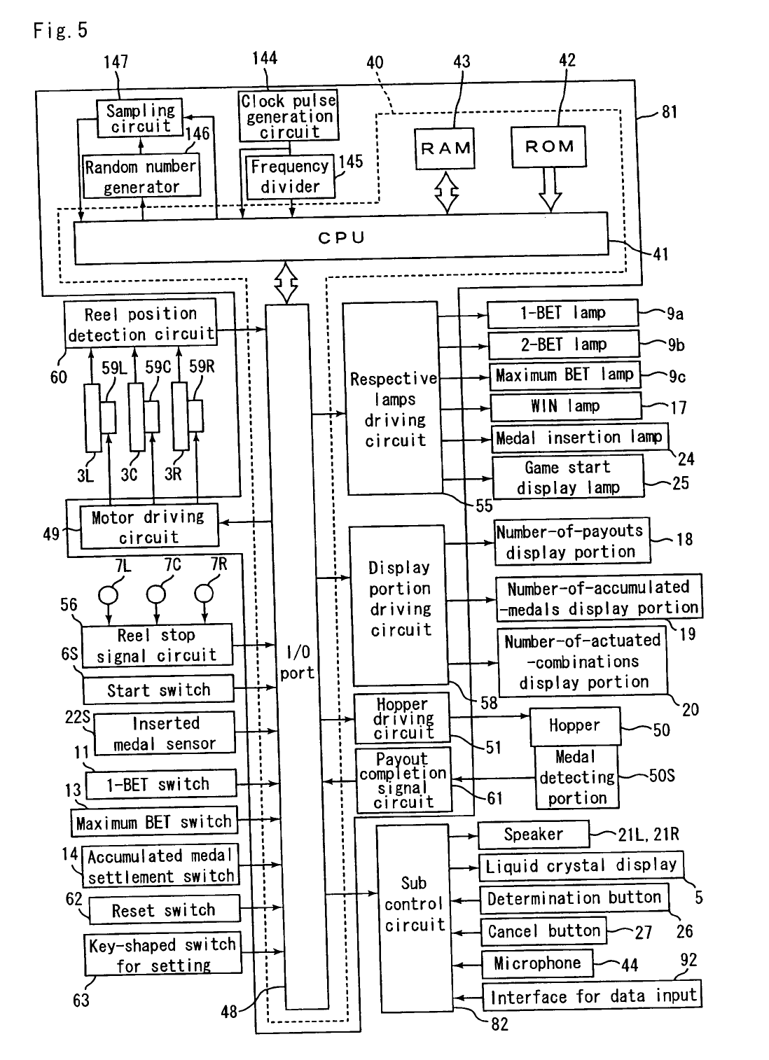

FIG. 6 is a block diagram showing a configuration of the sub control circuit shown in FIG. 5.

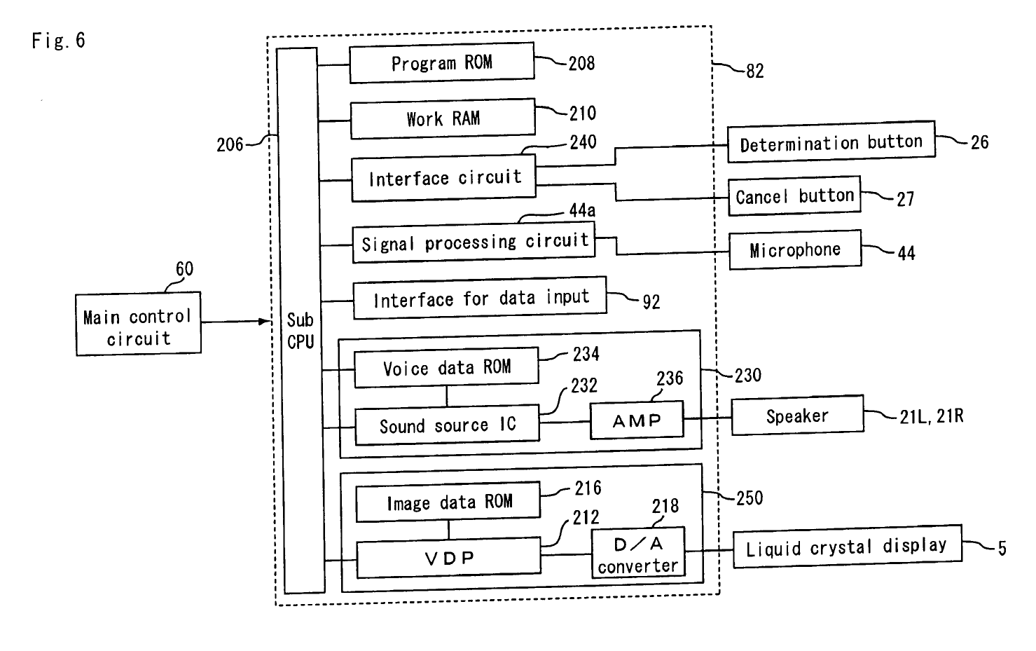

FIG. 7 (a) to FIG. 7 (c) are diagrams for explaining sound data stored in a voice data ROM.

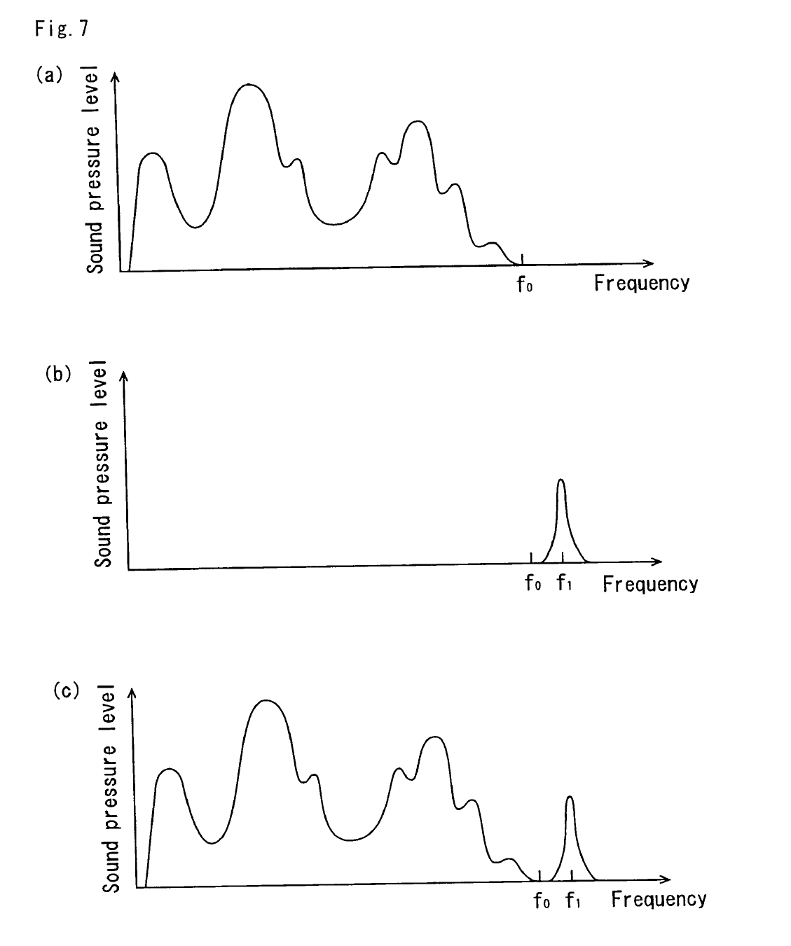

FIG. 8-1 and FIG. 8-2 are flowcharts showing a subroutine of game execution processing executed in a main control circuit.

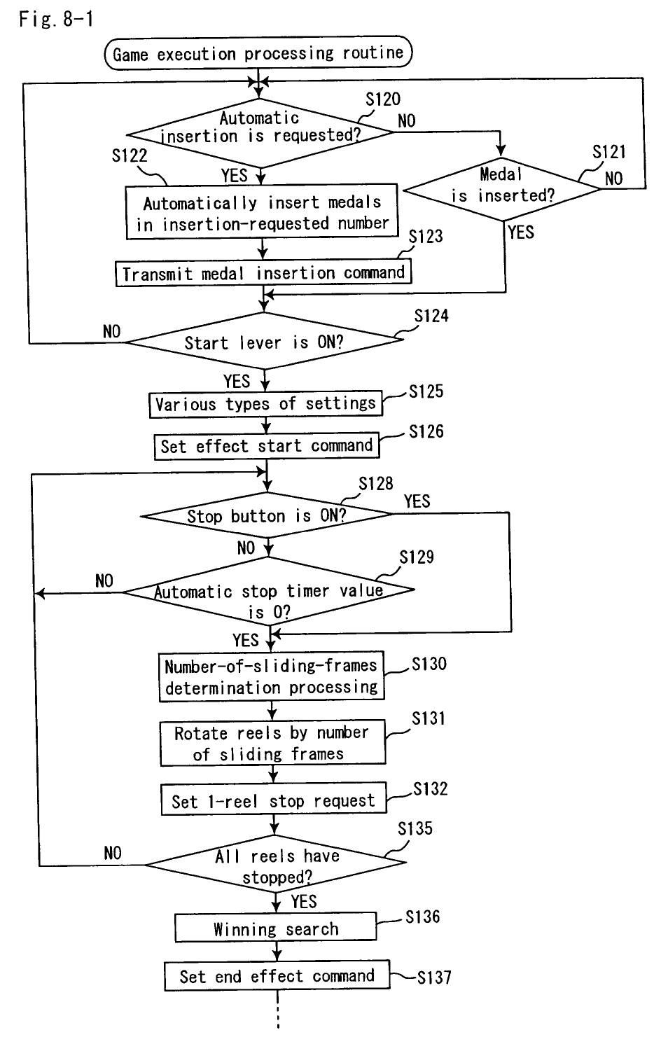

FIG. 9 is a flowchart showing a subroutine of sound recognition processing executed in the sub control circuit.

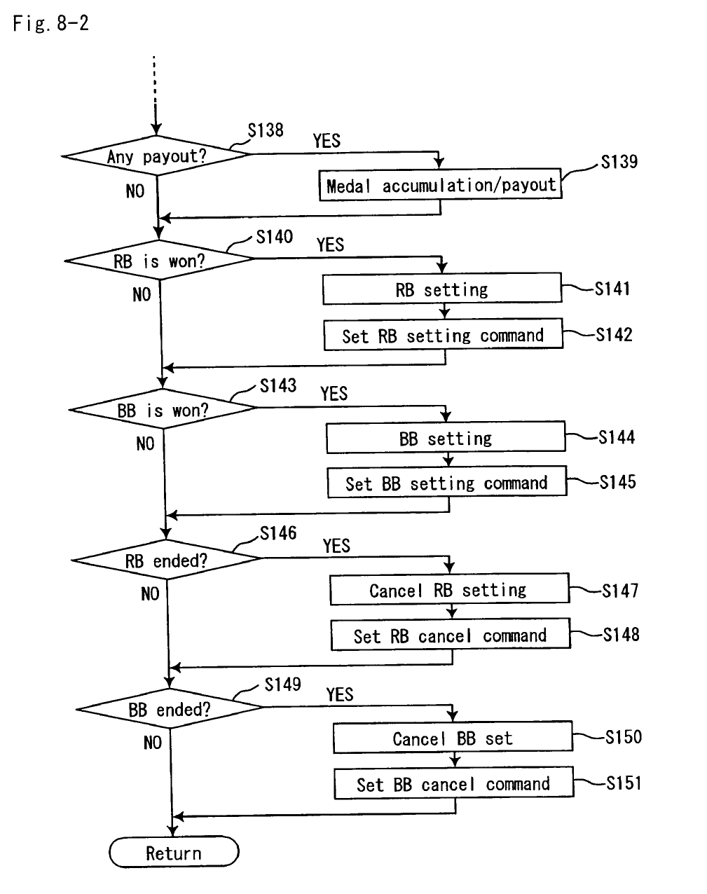

FIG. 10 is a flowchart showing a subroutine of command receiving processing executed in the sub control circuit.

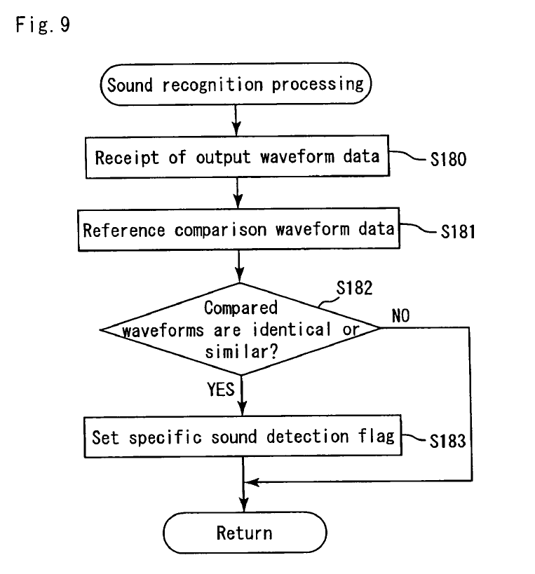

FIG. 11 is a flowchart showing a subroutine of sound output control processing executed in a voice control circuit.

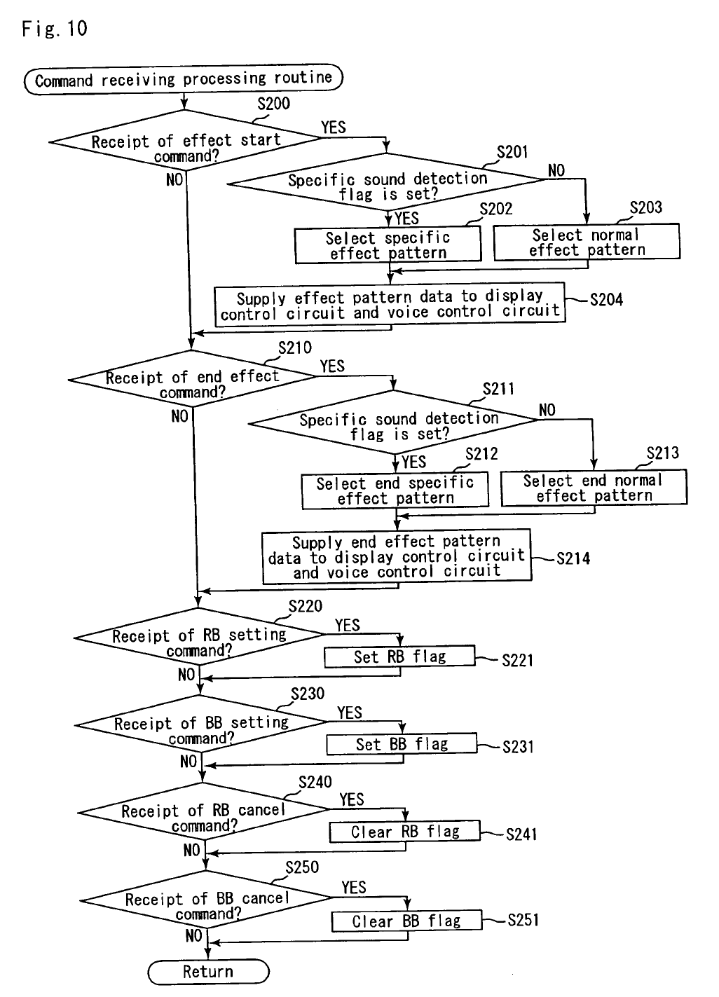

FIG. 12 is a flowchart showing a subroutine of display control processing executed in a display control circuit.

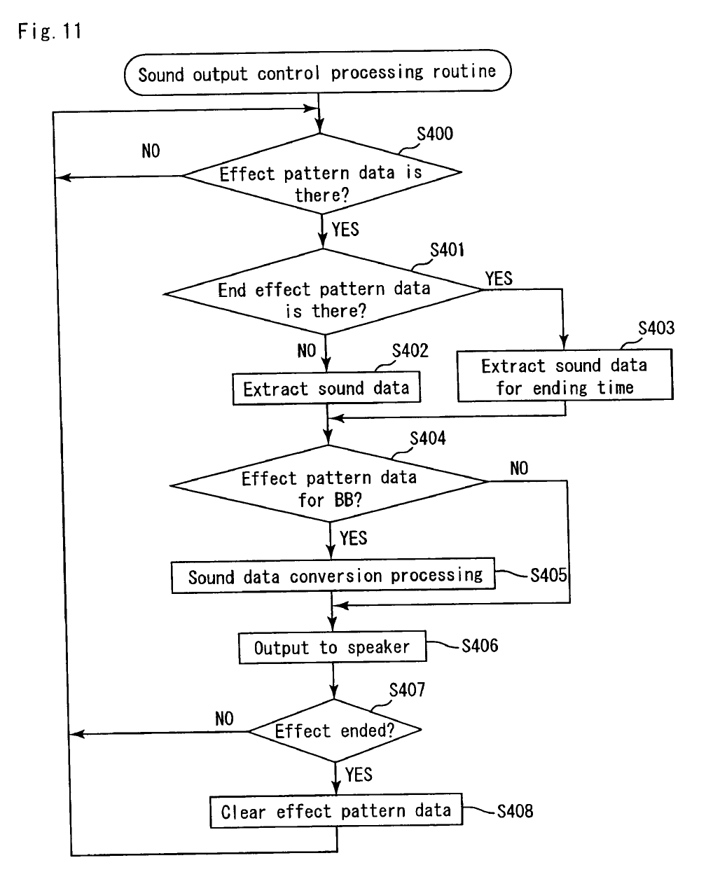

FIG. 13 is a diagram for explaining second sound data according to another example.

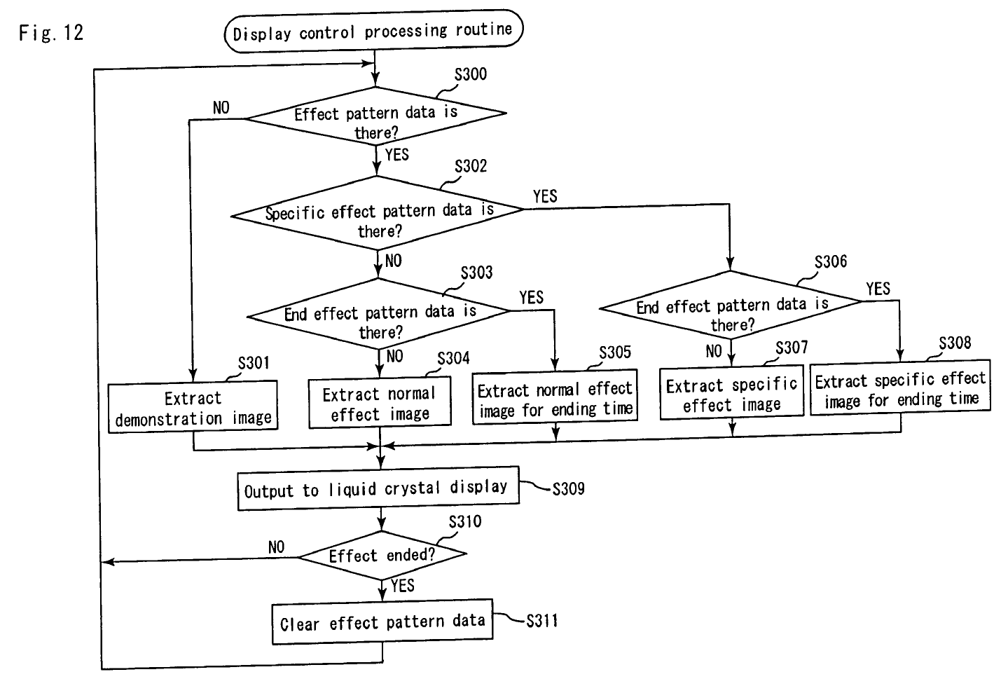

FIG. 14 is a perspective view schematically showing a slot machine according to a second embodiment of the present invention.

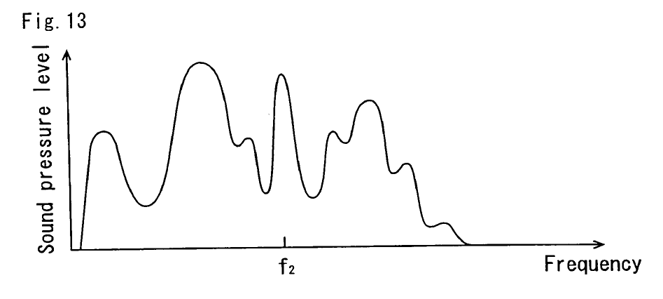

FIG. 15 is a diagram showing symbols and code Nos. of the respective symbols.

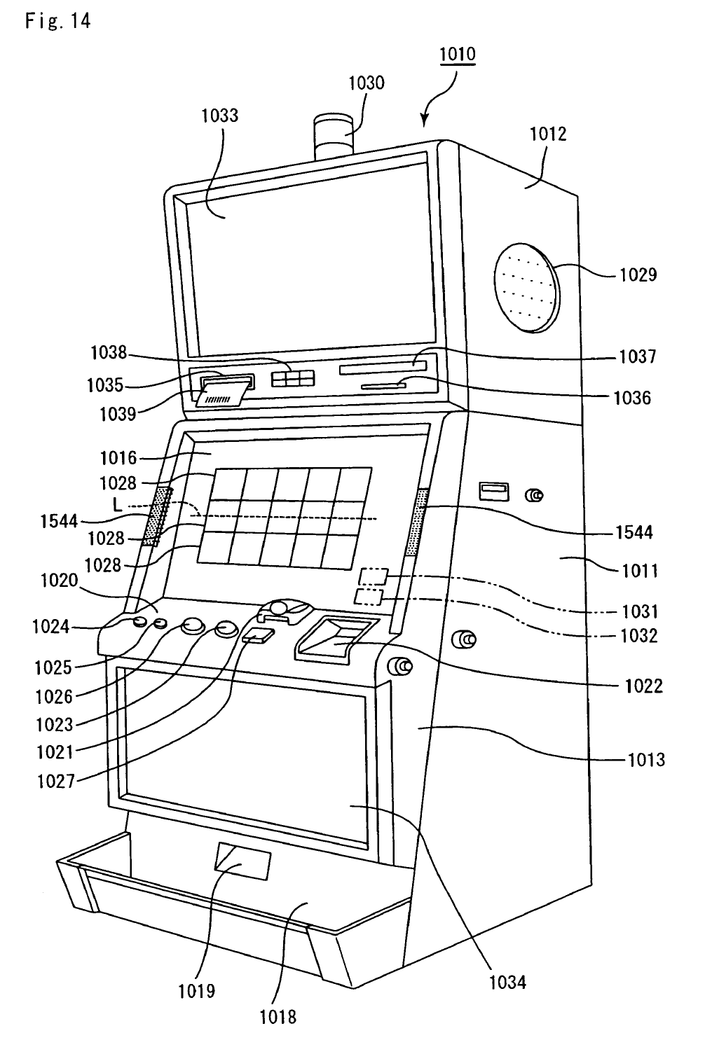

FIG. 16 is a block diagram showing an internal configuration of the slot machine shown in FIG. 14.

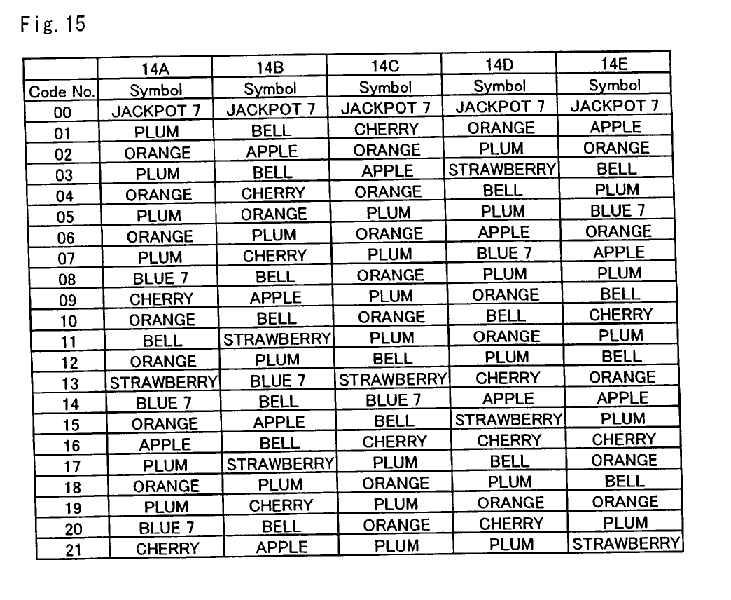

FIG. 17 is a flowchart showing a subroutine of sound recognition processing.

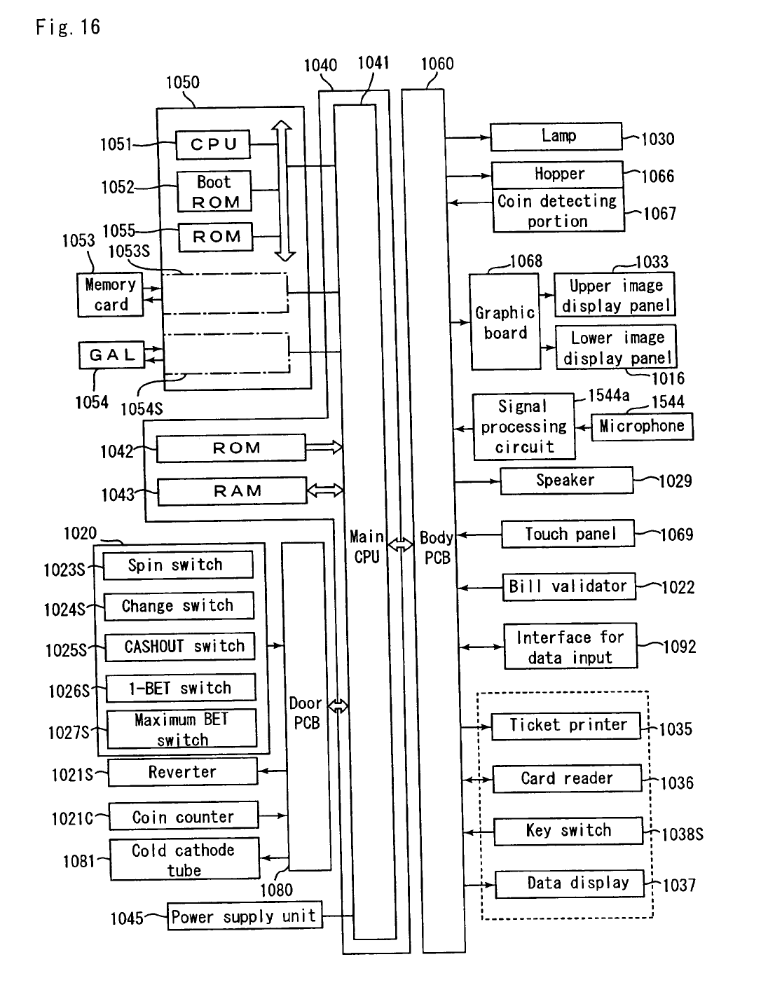

FIG. 18 is a flowchart showing a subroutine of game execution processing.

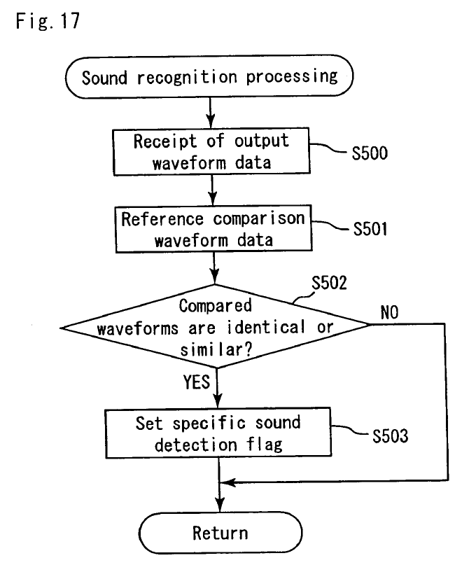

FIG. 19 is a view showing an example of images displayed to a lower image display panel.

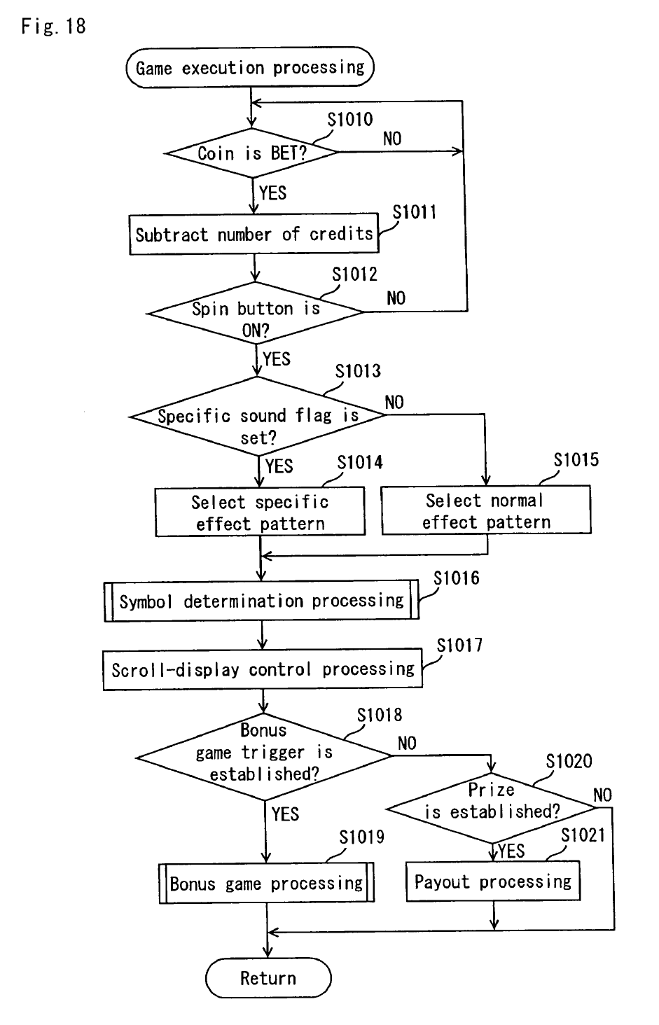

FIG. 20 is a flowchart showing a subroutine of symbol determination processing.

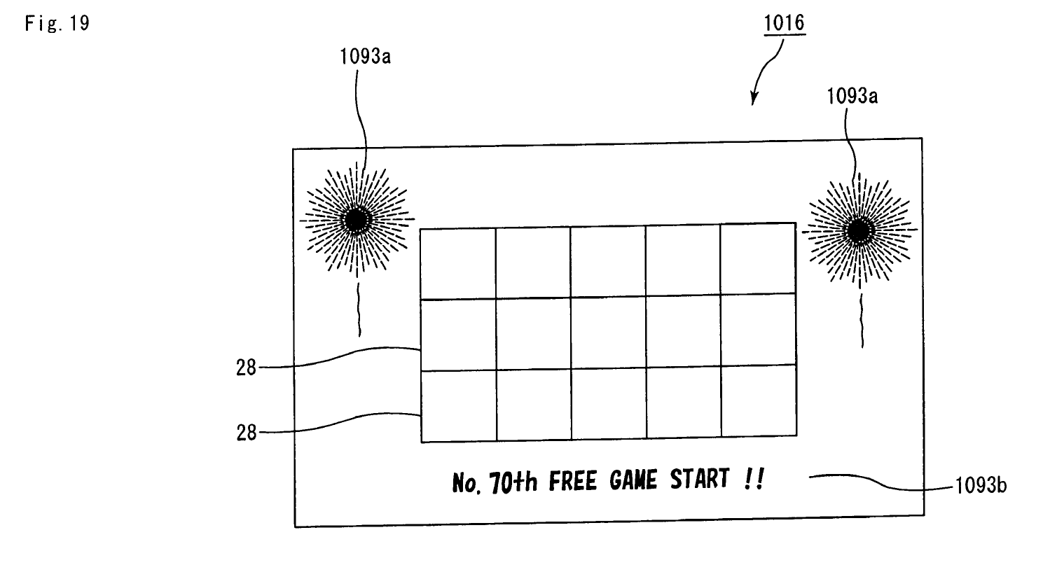

FIG. 21 is a diagram showing a relation between prizes and the numbers of payouts.

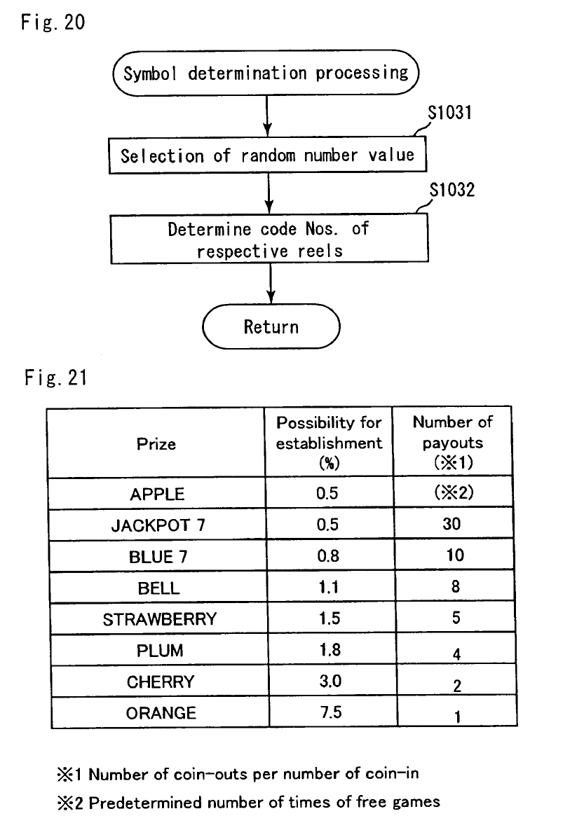

FIG. 22 is a flowchart showing a subroutine of bonus game processing.

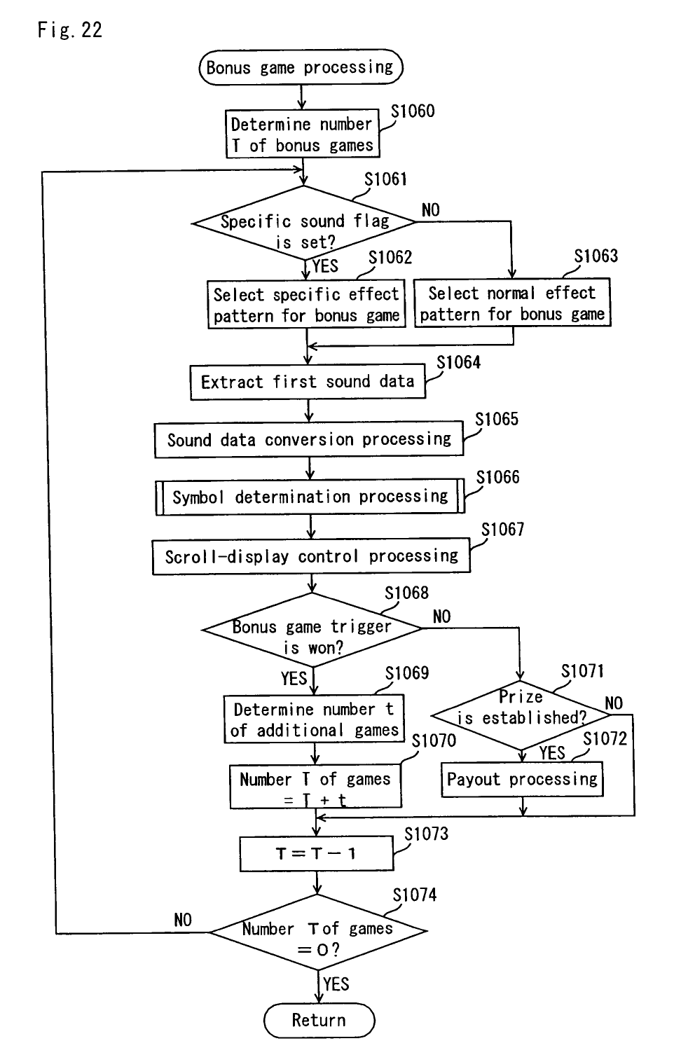

### EXPLANATION OF SYMBOLS

1 Pachislo gaming apparatus
2 Cabinet
3 (3L, 3C, 3R) Rotational reels
5 Liquid crystal display
21 (21L, 21R) Speakers
34 Transparent liquid crystal panel
36 Reflection film
41 CPU
42 ROM
43 RAM
44 Microphone
44a Signal processing circuit
82 Sub control circuit
92 Interface for data input
93 Specific effect image
206 Sub CPU
208 Program ROM
210 Work RAM
230 Voice control circuit
234 Voice data ROM
1010 Slot machine
1011 Cabinet
1016 Lower image display panel
1020 Control panel
1029 Speaker
1033 Upper image display panel
1040 Mother board
1041 Main CPU
1042 ROM
1043 RAM
1050 Gaming board
1060 Body PCB
1068 Graphic board
1069 Touch panel
1092 Interface for data input
1093 Specific effect image
1544 Microphone
1544a Signal processing circuit

1. A gaming machine provided with a speaker capable of outputting a sound that is inputted into an external device having a microphone and that enables said device to execute a specific effect when it is determined in said device that the sound includes a specific sound based upon specific data, said gaming machine comprising:
a first memory that stores effect pattern data including first sound data; and
a controller,
said controller programmed to execute the processing of
(a) extracting the effect pattern data from said first memory,
(b) performing control to execute an effect, based upon the extracted effect pattern data,
(c) converting, as triggered by satisfaction of a prescribed condition, the first sound data included in the extracted effect pattern data into second sound data including the specific data that triggers said external device to execute the specific effect, and
(d) outputting from said speaker the sound based upon the processed second sound data.

2. The gaming machine according to claim 1,
wherein
said controller performs, in said processing (c), processing of converting the first sound data included in the extracted effect pattern data into second sound data including the specific data that shows a specific waveform.

3. The gaming machine according to claim 2,
wherein
said controller performs, in said processing (c), processing of converting the first sound data included in the extracted effect pattern data into second sound data including the specific data that shows a waveform obtained by amplifying by a prescribed amount an amplitude in a specific frequency band of a waveform shown by the first sound data.

4. The gaming machine according to claim 2,
wherein
said controller performs, in said processing (c), processing of converting the first sound data included in the extracted effect pattern data into second sound data including the specific data that shows a waveform of a specific inaudible sound.

5. The gaming machine according to claim 2, further comprising a second memory that stores identification data identifying a gaming machine installed in a game parlor,
wherein
said controller performs, in said processing (c), processing of converting the first sound data included in the extracted effect pattern data into second sound data including the specific data that shows a specific waveform corresponding to said identification data.

6. The gaming machine according to claim 3,
wherein
said controller performs, in said processing (c), processing of converting the first sound data included in the extracted effect pattern data into second sound data including the specific data that shows a waveform of a specific inaudible sound.

7. The gaming machine according to claim 3, further comprising a second memory that stores identification data identifying a gaming machine installed in a game parlor,
wherein
said controller performs, in said processing (c), processing of converting the first sound data included in the extracted effect pattern data into second sound data including the specific data that shows a specific waveform corresponding to said identification data.

8. The gaming machine according to claim 4, further comprising a second memory that stores identification data identifying a gaming machine installed in a game parlor,
wherein
said controller performs, in said processing (c), processing of converting the first sound data included in the extracted effect pattern data into second sound data including the specific data that shows a specific waveform corresponding to said identification data.

9. The gaming machine according to claim 5, further comprising
an interface for inputting the identification data.

10. The gaming machine according to claim 7, further comprising
an interface for inputting the identification data.

11. The gaming machine according to claim 8, further comprising
an interface for inputting the identification data.

12. A gaming machine comprising:
a microphone that converts an input sound from the outside into a sound signal and outputs the signal;
a third memory that stores normal effect pattern data and specific effect pattern data, as effect pattern data; and
a controller,
said controller programmed to execute the processing of
(a) determining whether or not a sound indicated by the sound signal outputted from said microphone includes a specific sound based upon specific data, and
(b) controlling execution of an effect based upon said normal effect pattern data when it is determined that the sound indicated by the sound signal outputted from said microphone does not include the specific sound based upon the specific data, and controlling execution of an effect based upon said specific effect pattern data when it is determined that the sound indicated by the sound signal outputted from said microphone includes the specific sound based upon the specific data.

13. The gaming machine according to claim 12,
wherein
said controller determines, in said processing (a), whether or not part of a waveform of the sound indicated by the sound signal outputted from said microphone includes a waveform identical or similar to a specific waveform based upon the specific data, and
controls, in said processing (b), execution of an effect based upon said normal effect pattern data when it is determined that part of a waveform of the sound indicated by the sound signal outputted from said microphone does not include a waveform identical or similar to the specific waveform based upon the specific data, and controls execution of an effect based upon said specific effect pattern data when it is determined that part of the waveform of the sound indicated by the sound signal outputted from said microphone includes a waveform identical or similar to the specific waveform based upon the specific data.

14. The gaming machine according to claim 13,
wherein
said specific waveform is a waveform with an amplitude in a specific frequency band different by a prescribed amount from a reference amplitude.

15. The gaming machine according to claim 13,
wherein
said specific waveform is a waveform showing a specific inaudible sound.

16. The gaming machine according to claim 14,
wherein
said specific waveform is a waveform showing a specific inaudible sound.

17. A gaming machine provided with a speaker capable of outputting a sound that is inputted into an external device having a microphone and that enables said device to execute a specific effect when it is determined in said device that the sound includes a specific voice based upon specific data, said gaming machine comprising:
a first memory that stores effect pattern data including first sound data;
a fourth memory that stores voice data; and
a controller,
said controller programmed to execute the processing of
(a) extracting the effect pattern data from said first memory,
(b) performing control to execute an effect, based upon the extracted effect pattern data,
(c) extracting voice data from said fourth memory,
(d) converting, as triggered by satisfaction of a prescribed condition, first sound data included in the effect pattern data extracted in said processing (a) into second sound data including the voice data extracted in said processing (c), and
(e) outputting from said speaker the based upon the processed second sound data.

18. A gaming machine comprising:
a microphone that converts an input sound from the outside into a sound signal and outputs the signal;
a voice recognition device that determines whether or not a sound indicated by the sound signal outputted from said microphone includes a specific voice based upon specific data;
a third memory that stores normal effect pattern data and specific effect pattern data, as effect pattern data; and
a controller,
said controller programmed to execute the processing of
(a) controlling execution of an effect based upon said normal effect pattern data when said voice recognition device does not recognize the specific voice, and controlling execution of an effect based upon said specific effect pattern data when said voice recognition device recognizes the specific voice.
